(19) United States
(12) Patent Application Publication
(10) Pub. No.: US 2025/0217716 A1
(43) Pub. Date: Jul. 3, 2025

(54) COMPUTING SYSTEM AND METHOD FOR BUILDING AND EXECUTING AN ENSEMBLE MODEL FOR FORECASTING TIME-SERIES DATA

(71) Applicant: Discover Financial Services, Riverwoods, IL (US)

(72) Inventors: Yixin Sun, Itasca, IL (US); Bowen Wu, Chicago, IL (US); Zehao Li, Shanghai (CN); Shengkang Zhou, Shanghai (CN)

(21) Appl. No.: 18/430,107

(22) Filed: Feb. 1, 2024

Related U.S. Application Data
(63) Continuation of application No. PCT/CN2023/143405, filed on Dec. 29, 2023.

(51) Int. Cl. G06N 20/20

(52) U.S. Cl. CPC G06N 20/20

(57) ABSTRACT

A computing platform is configured to (i) generate first and second sets of time-series models for forecasting values of a time-series variable for respective and different first and second timeframes, the first and second sets each comprising models of different types, (ii) (ii) receive configuration data for an ensemble model that identifies a user-selected group of time-series models to be included in the ensemble model, where the user-selected group includes at least one model from the first set and at least one model from the second set, (iii) based on the received configuration data, construct the ensemble model from the user-selected group of time-series models, where the ensemble model is configured to blend the forecast values of the time-series variable that are predicted by the user-selected group of time-series models, and (iv) utilize the ensemble model to predict a given sequence of forecast values for the time-series variable.

### CROSS-REFERENCE TO RELATED APPLICATIONS

This application is a continuation of International Application No. PCT/CN2023/143405, filed on Dec. 29, 2023 and entitled “COMPUTING SYSTEM AND METHOD FOR BUILDING AND EXECUTING AN ENSEMBLE MODEL FOR FORECASTING TIME-SERIES DATA,” the contents of which are hereby incorporated by reference in their entirety.

### BACKGROUND

Time-series data generally comprises a sequence of values for one or more data variables that are recorded over time, where each such data variable may be referred to as a “time-series variable.” Various organizations utilize time-series data to record and track how the values of certain time-series variables change over time, which may allow meaningful insights to be derived about the time-series variables themselves and perhaps also other data variables that are impacted by the time-series variables. For instance, based on an analysis of the recorded values for a time-series variable, temporal patterns may be identified and utilized to explain the past behavior of the time-series variable (and/or other data variables) or to forecast the future behavior of the time-series variable (and/or other data variables), among other possibilities.

### SUMMARY

Disclosed herein is new technology for building and executing models for forecasting time-series data.

In one aspect, the disclosed technology may take the form of a method to be carried out by a computing platform that involves (i) generating a first set of time-series models that are configured to predict forecast values of a target time-series variable for a first target timeframe, wherein the first set of time-series models comprises time-series models of at least two different model types, (ii) generating a second set of time-series models that are configured to predict forecast values of a target time-series variable for a second target timeframe that differs from the first target timeframe, wherein the second set of time-series models comprises time-series models of at least two different model types, (iii) causing a client device associated with a user to present a graphical user interface (“GUI”) that enables a user to configure an ensemble model for forecasting values of the target time-series variable, (iv) receiving, from the client device over a network-based communication path, configuration data for a given ensemble model that identifies a user-selected group of time-series models to be included in the given ensemble model, wherein the user-selected group of time-series models includes at least one time-series model from the first set of time-series models and at least one time-series model from the second set of time-series models, (v) based on the received configuration data, constructing the given ensemble model from the user-selected group of time-series models, wherein the given ensemble model is configured to blend forecast values of the target time-series variable that are predicted by the user-selected group of time-series models, and (vi) after constructing the given ensemble model, utilizing the given ensemble model to predict a given sequence of forecast values for the target time-series variable.

The foregoing method may further involve additional functionality. For example, the method may additionally involve, before generating the first and second sets of time-series models, obtaining model setup parameters and source data for use in generating the first and second sets of time-series models. As another example, the method may additionally involve causing the client device associated with the user to present the given sequence of forecast values for the target time-series variable. As yet another example, the method may additionally involve, before generating the first and second sets of time-series models, (i) obtaining historical data for the target time-series variable, (ii) obtaining historical data for one or more offset variables, and (iii) normalizing the historical data for the target time-series variable based on the historical data for one or more offset variables, wherein the first and second sets of time-series models are thereafter generated based on the normalized historical data for the target time-series variable.

The functionality for generating the first set of time-series models may take various forms, and in some examples, this functionality may involve, for each given model type, (i) training a given batch of candidate time-series models of the given model type that are configured to predict forecast values of the target time-series variable for the first target timeframe, wherein the candidate time-series models in the given batch have different hyperparameter combinations (e.g., hyperparameter combinations that are selected using a technique such as grid search), (ii) based on an evaluation of the given batch of candidate time-series models of the given model type, determining a respective measure of performance (e.g., a mean absolute percentage error (MAPE) value) for each of the different hyperparameter combinations, (iii) identifying hyperparameter combination that has a best measure of performance relative to other hyperparameter combinations, and (iv) selecting a candidate time-series model having the identified hyperparameter combination as a time-series model of the given model type to include in the first set of time-series models.

Likewise, the functionality for generating the second set of time-series models may take various forms, and in some examples, this functionality may involve, for each given model type, (i) training a given batch of candidate time-series models of the given model type that are configured to predict forecast values of the target time-series variable for the second target timeframe, wherein the candidate time-series models in the given batch have different hyperparameter combinations (e.g., (e.g., hyperparameter combinations that are selected using a technique such as grid search), (ii) based on an evaluation of the given batch of candidate time-series models of the given model type, determining a respective measure of performance (e.g., a MAPE value) for each of the different hyperparameter combinations, (iii) identifying hyperparameter combination that has a best measure of performance relative to other hyperparameter combinations, and (iv) selecting a candidate time-series model having the identified hyperparameter combination as a time-series model of the given model type to include in the second set of time-series models.

Further, the at least two different model types of the first set of time-series models and the at least two different model types of the second set of time-series models both may take various forms. For example, the at least two different model types of the first set of time-series models and the at least two different model types of the second set of time-series models each comprises at least two of (i) a Seasonal Autoregressive Integrated Moving-Average with exogenous regressors (SARIMAX) type of time-series model, (ii) an Unobserved Components type of time-series model, (iii) an Exponential Smoothing type of time-series model, or (iv) a Prophet type of time-series model, among other possible examples.

Further yet, each of the time-series models in the first and second sets may take various forms. For example, the time-series models in the first and second sets may each have a first input feature corresponding to the target time-series variable and one or more additional input features corresponding to one or more influencing variables.

Still further, the given ensemble model may take various forms. In some examples, the given ensemble model may be configured to blend the forecast values of the target time-series variable that are output by the at least one time-series model from the first set of time-series models for the first target timeframe across time with the forecast values of the target time-series variable that are output by at least one time-series model from the second set of time-series models for the second target timeframe.

In other examples, the user-selected group of time-series models may include two or more time-series models from the first set of time-series models, the configuration data comprises a respective weight value for each of the two or more time-series models from the first set of time-series models, and the given ensemble model may be configured to blend the forecast values of the target time-series variable that are output by the two or more time-series models from the first set of time-series models in accordance with the respective weight values.

In another aspect, disclosed herein is a computing platform that includes at least one processor, at least one non-transitory computer-readable medium, and program instructions stored on the at least one non-transitory computer-readable medium that are executable by the at least one processor to cause the computing platform to carry out the functions disclosed herein, including but not limited to the functions of the foregoing method.

In yet another aspect, disclosed herein is a non-transitory computer-readable medium that is provisioned with program instructions that are executable to cause a computing platform to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 depicts one illustrative example of a computing environment in which the disclosed time-series forecasting tool may be implemented.

FIG. 2 is a flow diagram that illustrates example functionality that may be carried out by a computing platform installed with an example model setup component in order to obtain and prepare setup data that is to be utilized in building a new ensemble model.

FIG. 3A illustrates an example first GUI view comprising input elements that enable a user to input model setup parameters and/or indicate source data for the ensemble model.

FIG. 3B illustrates an example second GUI view comprising a target variable input element, which may be utilized, by a user via a client device, to input and/or edit values for a target time-series variable that are intended for use in training the ensemble model.

FIG. 3C illustrates an example third GUI view comprising an influencing variable input element that enables a user to input and/or edit values for any influencing variables that are intended for use in training the ensemble model.

FIG. 3D illustrates an example fourth GUI view comprising an offset data input element that enables a user to input and/or edit values for any offset data variables that are intended for use in training the ensemble model.

FIG. 4 depicts a conceptual illustration of one example embodiment of a model building component, which is shown to include an example time-series model generation sub-component and an example ensemble model configuration sub-component.

FIG. 5 is a flow diagram that illustrates example functionality that may be carried out by a computing platform installed with the time-series model generation sub-component of FIG. 4 in order to generate a given set of time-series models.

FIG. 6 is a flow diagram that illustrates example functionality that may be carried out by a computing platform installed with the ensemble model configuration sub-component of FIG. 4 in order to build an ensemble model based on a selected subset of time-series models.

FIG. 7 illustrates an example GUI view comprising input elements that enable a user to input (i) a selection of one or more time-series models from first and second sets of time-series models and, optionally, (ii) corresponding weights for blending the forecast values output by each of the multiple time-series models for the ensemble model.

FIG. 8 depicts a conceptual illustration of one possible example of an ensemble model that may be constructed in accordance with the disclosed software technology.

FIG. 9 is a flow diagram that illustrates example functionality that may be carried out by a computing platform installed with an example model execution component in order to execute an ensemble model that was built using an example model building component.

FIG. 10A illustrates a first example GUI view for a model execution GUI that enables a user to initiate execution of an ensemble model.

FIG. 10B illustrates a second example GUI view for the model execution GUI that enables a user to view an output of an ensemble model.

FIG. 11 illustrates an example GUI view for a model evaluation GUI that that enables a user to view a version-over-version (“VoV”) comparison.

FIG. 12 is a simplified block diagram illustrating some structural components that may be included in an example computing platform that may be configured to perform some or all of the server-side functions disclosed herein.

FIG. 13 is a simplified block diagram is illustrating some structural components that may be included in an example client device that may be configured to perform some or all of the client-side functions disclosed herein.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

As noted above, time-series data generally comprises a sequence of values for one or more data variables that are recorded over time, where each such data variable may be referred to as a “time-series variable.” For instance, time-series data comprising a single time-series variable (which may be referred to as “univariate time-series data”) may take the form of a two-dimensional dataset wherein a first dimension represents time and a second dimension represents the value of the time-series variable. Along similar lines, time-series data comprising multiple time-series variables (which may be referred to as “multivariate time-series data”) may take the form of a multi-dimensional dataset wherein a first dimension represents time and then the other dimensions represent the values of the multiple time-series variables. In such a time-series dataset, the values for each time-series variable are typically recorded at regular time intervals, examples of which may include hourly intervals, daily intervals, weekly intervals, monthly intervals, or yearly intervals, among other possible examples, which allows an interested party to track the changes in the time-series variable's value over time. Some representative examples of time-series variables include data variables related to sales volume, call center volume, transaction volume, inventory, stock prices, interest rates, income, spending habits, computer and/or networking activity (e.g., observability metrics), population, weather tracking (e.g., temperature, rainfall, etc.), and health tracking (e.g., weight, heart rate, etc.), among many others.

Various organizations utilize time-series data to record and track how the values of certain time-series variables change over time, which may allow meaningful insights to be derived about the time-series variables themselves and perhaps also other data variables that are impacted by the time-series variables. For instance, based on an analysis of the recorded values for a time-series variable, temporal patterns may be identified and utilized to explain the past behavior of the time-series variable (and/or other data variables) or to forecast the future behavior of the time-series variable (and/or other data variables), among other possibilities.

To illustrate with an example, a business organization that operates a call center may record and track values of certain time-series variables related to call center volume (e.g., (e.g., number of calls offered (NCO)) over time, which may then allow the business organization to derive meaningful insights based on that time-series data. For instance, based on an analysis of the recorded values for the time-series variable related to call center volume, the business organization may be able to forecast future values for the time-series variable, which may then allow the business organization to better plan operations for the call center (e.g., labor needs, equipment needs, hiring demands, etc.). Many other examples are possible as well.

Various computer-based technologies currently exist for analyzing and forecasting time-series data. For instance, various complex, computer-based technologies currently exist for generating time-series forecasting models that are configured to forecast future values of a time-series variable, including but not limited to technologies for training time-series forecasting models using a regression technique or some other machine learning technique (e.g., a neural network) and tuning the hyperparameters of such time-series models using a technique such as grid search or random search. In practice, these technologies involve advanced functionality that requires the use of high-powered computers and typically utilize large volumes of complex time-series data that cannot be practically evaluated by humans.

However, the existing computer-based technologies for analyzing and forecasting time-series data have a number of drawbacks and problems. For instance, one problem with existing computer-based technologies for generating time-series forecasting models is that they typically fail to account for the fact that the historical time-series data used to train such time-series forecasting models may have been impacted by certain contributing factors that are not expected to continue into the future (e.g., random events, such as a natural disaster, a pandemic, etc.) and/or may not account for certain contributing factors that are expected to impact the future values, which may lead to inaccurate forecasts.

Another problem with existing computer-based technologies for generating time-series forecasting models is that each different type of time-series forecasting model technology typically has its own relative strengths and weaknesses, particularly as it relates to forecasting performance (e.g., prediction accuracy). For instance, some types of time-series forecasting model technologies may have better prediction accuracy when forecasting values for shorter-term timeframes (e.g., the first 6 months after the model is executed) but may have degraded prediction accuracy when forecasting values for longer-term timeframes (e.g., 6 or more months into the future), whereas other types of time-series forecasting model technologies may have better prediction accuracy when forecasting values for longer-term timeframes (e.g., 6 or more months into the future) but may have degraded prediction accuracy when forecasting values for shorter-term timeframes (e.g., the first 6 months after the model is executed). Further, some types of time-series forecasting model technologies may have better prediction accuracy when forecasting values based on historical data for the target time-series variable alone, whereas other types of time-series forecasting model technologies may have better prediction accuracy when forecasting values based on historical time-series data for the target time-series variable as well as data for other variables that have an influencing effect on the values of the target time-series variable. Further yet, some types of time-series forecasting model technologies are better than others at capturing the underlying dynamics of the data utilized to train and tune the time-series forecasting model.

Yet another problem with existing computer-based technologies for generating time-series forecasting models is that those technologies are typically designed for use by individuals with specialized knowledge and experience in the field of time-series forecast modeling (e.g., data scientists or the like), and as such, are generally not suitable for use by other “non-expert” individuals that may wish to analyze and forecast time-series data, which limits the usefulness and value of existing technologies. Indeed, generating time-series forecasting models using existing technologies is typically a complex, cumbersome, time consuming, and resource intensive task that can only be carried out by a limited subset of qualified individuals. This introduces more time delay and cost into the process of generating time-series forecasting models.

Still another problem with existing computer-based technologies for generating time-series forecasting models is that such technologies often require each new category of time-series forecasting model to be created from scratch, rather than leveraging the commonalities between different categories of time-series forecasting models in order to streamline the process of creating new categories of time-series forecasting models. As a result, the existing computer-based technologies for generating time-series forecasting models lacks scalability.

A further problem with existing computer-based technologies for generating and executing time-series forecasting models is that, when dealing with complex time-series forecasting models, the predicted time-series forecast values may lack transparency and/or be unexplainable, which may degrade the usefulness of the time-series forecast values. For instance, if predicted time-series forecast values cannot be explained, then there may be less confidence in the accuracy of those predictions and that may in turn limit how those predicted time-series forecast values can be used.

The existing computer-based technologies for analyzing and forecasting time-series data suffer from other problems as well.

To address these and other problems with the existing technology for analyzing and forecasting time-series data, disclosed herein is a new software tool for building and executing time-series forecasting models, which may be referred to herein as the “time-series forecasting tool.” In practice, the disclosed time-series forecasting tool may take the form of a software application that is hosted on a back-end computing platform and is accessible by client devices over a communication path that typically includes the Internet (among other data networks that may be included). In this respect, the disclosed time-series forecasting tool may comprise server-side software installed on the back-end computing platform as well as client-side software that runs on the client devices and interacts with the server-side software, which could take the form of a client application running in a web browser (sometimes referred to as a “web application”), a native desktop application, or a mobile application, among other possibilities. However, the disclosed time-series forecasting tool could take other forms and/or be implemented in other manners as well.

At a high level, the disclosed time-series forecasting tool may include functionality for setting up, building, and executing an ensemble model that is configured to forecast time-series data, which may then be presented to users of the time-series forecasting tool. In accordance with the present disclosure, the ensemble model that is built using the time-series forecasting tool may comprise any model that is configured to blend the forecast values of a target time-series variable that are predicted by (i) a first set of one or more models for a first timeframe in the future and (ii) a second set of one or more models for a second timeframe in the future. Additionally, the disclosed time-series forecasting tool may include functionality for evaluating the output and/or performance of the ensemble model that is built using the time-series forecasting tool, which may then inform decision-making as to whether to use the current version of the ensemble model to forecast time-series data and/or whether to set up and build an updated version of the ensemble model. The functionality of the disclosed time-series forecasting tool may also take other forms and is described in further detail below.

The disclosed time-series forecasting tool improves upon the existing computer-based technologies for analyzing and forecasting time-series data in a number of ways. For instance, as explained below, the disclosed time-series forecasting tool provides a mechanism for adjusting the historical data for the target time-series variable prior to training the time-series forecasting models to back out and/or add in any contributing factors that could otherwise lead to inaccurate forecasts. Further, the disclosed time-series forecasting tool is designed for building an ensemble model that is configured to blend the predictions of multiple different time-series forecasting models, which tends to be more accurate than an individual time-series forecasting model because the ensemble model leverages the relative strengths of multiple different time-series forecasting models (e.g., models of different types and/or models that are tuned for different target timeframes). Further yet, the disclosed time-series forecasting tool allows time-series forecasting models to be built via user-friendly interfaces and workflows that can be used by both “expert” and “non-expert” users that wish to analyze and forecast time-series data, which decreases the complexity, time, and resources involved in the task of building a time-series forecasting model such that a wide range of users can begin to engage in that task. Still further, the disclosed time-series forecasting tool leverages the commonalities between different categories of time-series forecasting models in a way that streamlines the process of creating new categories of time-series forecasting models, thereby providing a more scalable solution than existing technologies. Still further yet, the disclosed time-series forecasting tool may provide features that improve transparency and explanability of the forecast values predicted by time-series forecasting models.

As demonstrated below, the disclosed time-series forecasting tool improves upon the existing computer-based technologies for analyzing and forecasting time-series data in various other ways as well.

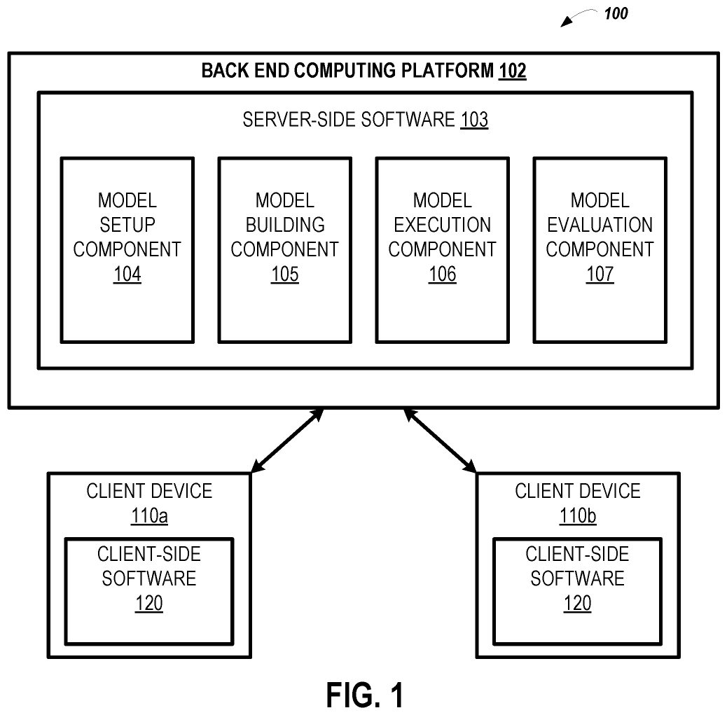

Turning now to the figures, FIG. 1 depicts one illustrative example of a computing environment 100 in which the disclosed time-series forecasting tool may be implemented. As shown, the computing environment 100 may include a back-end computing platform 102 and a plurality of client devices 110, of which client devices 110a and 110b are shown as examples.

The back-end computing platform 102 may comprise any one or more computer systems (e.g., one or more servers) that have been installed with server-side software 103 of the disclosed time-series forecasting tool, which may configure the back-end computing platform 102 to carry out the server-side functionality disclosed herein. For purposes of illustration and discussion, server-side software 103 is shown as including a model setup component 104, a model building component 105, a model execution component 106, and a model evaluation component 108, but it should be understood that server-side software 103 could take various other forms as well.

In practice, the one or more computer systems of the back-end computing platform 102 may collectively comprise some set of physical computing resources (e.g., one or more processors, data storage systems, communication interfaces, etc.), which may take any of various forms. As one possibility, the back-end computing platform 102 may comprise cloud computing resources supplied by a third-party provider of “on demand” cloud computing resources, such as Amazon Web Services (AWS), Amazon Lambda, Google Cloud, Microsoft Azure, or the like. As another possibility, the back-end computing platform 102 may comprise “on-premises” computing resources of organization that operates the back-end computing platform 102 (e.g., servers owned by the organization that operates the back-end computing platform 102). As yet another possibility, the back-end computing platform 102 may comprise a combination of cloud computing resources and on-premises computing resources. Other implementations of the back-end computing platform 102 are possible as well.

Further, in practice, the server-side software 103 of the disclosed time-series forecasting tool may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

Further yet, although not shown in FIG. 1, the server-side software 103 for the disclosed time-series forecasting tool may interact with a data storage layer of the back-end computing platform 102, which may comprise data stores of various different forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, or streaming event queues, among other possibilities.

The example back-end computing platform 102 may comprise various other components and take various other forms as well.

Turning to the client devices 110, in general, each of example client devices 110a, 110b may take the form of any computing device that is capable of running client-side software 120 of the disclosed time-series forecasting tool, which as noted above may take the form of a client application that runs in a web browser, a native desktop application, or a mobile application, among other possibilities. In this respect, each of example client devices 110a, 110b may include hardware components such as one or more processors, data storage, communication interfaces, and input/output (I/O) components (or interfaces for connecting thereto), among other possible hardware components, as well as software components such as operating system (OS) software, web browser software, and/or the client-side software 120 of the disclosed time-series forecasting tool, among other possible software components. As representative examples, each of example client devices 110a, 110b may take the form of a desktop computer, a laptop, a netbook, a tablet, a smartphone, or a personal digital assistant (PDA), among other possibilities.

As further depicted in FIG. 1, each of example client devices 110a, 110b may be configured to communicate with the back-end computing platform 102 over a respective communication path. Each of these communication paths may generally comprise one or more data networks and/or data links, which may take any of various forms. For instance, each respective communication path between an example client device 110a, 110b and the back-end computing platform 102 may include any one or more of a Personal Area Network (PAN), a Local Area Network (LAN), a Wide Area Networks (WAN) such as the Internet or a cellular network, a cloud network, and/or a point-to-point data link, among other possibilities, where each such data network and/or link may be wireless, wired, or some combination thereof, and may carry data according to any of various different communication protocols. Additionally, the communication between an example client device 110a, 110b and the back-end computing platform 102 may be carried out via an Application Programming Interface (API) provided by the back-end computing platform 102, among other possibilities. Although not shown, the respective communication paths between the example client devices 110a, 110b and the back-end computing platform 102 may also include one or more intermediate systems, examples of which may include a data aggregation system or a host server, among other possibilities. Many other configurations are also possible.

It should be understood that the computing environment 100 is one example of a computing environment in which the disclosed software technology may be implemented, and that numerous other examples of computing environments are possible as well.

The functionality of the server-side software 103 and client-side software 120 of the disclosed time-series forecasting tool will be now described in further detail.

To begin, at a high level, the example model setup component 104 of the server-side software 103 may cause the back-end computing platform 102 to carry out functionality for obtaining and preparing setup data that is to be utilized by the model building component 105 during the process of building a new ensemble model that is configured to forecast time-series data. In accordance with the present disclosure, that setup data may include at least (i) model setup parameters and (ii) source data for use in building the new ensemble model.

In general, the model setup parameters that are obtained by the model setup component 104 may comprise any parameters that are to be utilized by the model building component 105 during the process of building the new ensemble model. Such model setup parameters may take any of various forms.

For instance, one type of model setup parameter that may be obtained by the model setup component 104 may comprise a specification of a target time-series variable that is to be forecast by the new ensemble model. In line with the discussion above, the target time-series variable could comprise any variable for which values are recorded over time, and as some representative examples, the target time-series variable could be a variable that indicates the cost of a good or service, the population of a given geographic region, the volume of a certain type of customer activity (e.g., call volume), or the value of a certain weather metric, among various other examples.

Another type of model setup parameter that may be obtained by the model setup component 104 may comprise a specification of any one or more influencing variables (or sometimes referred to as “regressor variables”) that are to serve as input(s) to the new ensemble model, where an influencing variable may comprise any variable that is expected to have some causal relationship with the target time-series variable (e.g., a variable with which the target time-series variable has a statistical dependency). In other words, an influencing variable may comprise any variable whose values are expected to have some form of influence on the values of the target time-series variable.

To illustrate with one representative example, if the target time-series variable that is to be forecast by the new ensemble model is the number of calls received by a call center related to a given unit of a business organization, an influencing variable that could be specified for the new ensemble model could be the number of transactions related to the given unit of the business organization, as the number of transactions may influence (i.e., may be a driver for) the number of calls received by a call center. Other types of variables that influence call center volume could be specified as well, such as a number of newly-opened accounts related to the given business unit.

To illustrate with another representative example, if the target time-series variable that is to be forecast by the new ensemble model is sales volume for a given product line, an influencing variable that could be specified for the new ensemble model could be the advertising spend for the given product line, as the advertising spend for the given product line may influence (i.e., may be a driver for) the sales volume. Other types of variables that influence sales volume could be specified as well.

The types of influencing variables that could be specified for the new ensemble model could take various other forms as well.

Yet another type of model setup parameter that may be obtained by the model setup component 104 may comprise a specification of any one or more offset variables that are to be backed out of or added into the target time-series variable in order to normalize (or “clean”) the values for the target time-series variable. For instance, the model setup component 104 may obtain a specification of (i) an offset variable that indicates what portion of the target time-series variable's historical values were attributable to a factor that should be backed out of the target time-series variable, such as a random historical event that is not expected to occur in the future (e.g., a natural disaster, a pandemic, etc.) or some other contributing factor to the target time-series variable's historical values that should not be included in the forecast (e.g., a contributing factor that can be forecast separately and then added back into the forecast values for the target time-series variable), and/or (ii) an offset variable that indicates a value attributable to a factor that should be added into the target time-series variable, such as a contributing factor to the target time-series variable's historical values that was not accounted for in the obtained historical data for the target time-series variable.

Still another type of model setup parameter that may be obtained by the model setup component 104 may comprise a specification of time resolution for the new ensemble model, which may define the length of the time intervals between consecutive values within the time-series data that is input and output by the new ensemble model (i.e., the sampling frequency of the time-series data). In general, the time resolution for the new ensemble model may define the time intervals between consecutive time-series values in terms of any possible unit of time, including but not limited to any number of minutes, hours, days, weeks, months, or years between consecutive values. To illustrate with some representative examples, the time resolution for the ensemble model could be an hourly (or multi-hour) time resolution, a daily (or multi-day) time resolution, a weekly (or multi-week) time resolution, a monthly (or multi-month) time resolution, or a yearly (or multi-year) time resolution, among various other examples.

A further type of model setup parameter that may be obtained by the model setup component 104 may comprise a specification of a forecast (or “look-forward”) window for the ensemble model, which defines the time window in the future for which the ensemble model is to forecast values for the target time-series variable. For instance, the forecast window for the new ensemble model could comprise a time window that begins at the time the ensemble model is executed (or at some time thereafter) and extends any number of days, weeks, months, or years into the future (e.g., 12 months into the future, 24 months into the future, 36 months into the future, etc.). The forecast window for the new ensemble model could take various other forms as well.

Additionally, along with the model setup parameter specifying the forecast window, the model setup parameters obtained by the model setup component 104 may include a specification of how the forecast window is to be parsed into different sub-windows for purposes of blending predicted values that are output by the different sets of models that make up the ensemble model. For instance, as noted above and described in further detail below, a new ensemble model built in accordance with the present disclosure may be configured to blend the predicted values of the target time-series variable that are output by (i) a first set of one or more models for a first timeframe in the future (e.g., a shorter-term target timeframe such as the first 6 months after the date that the ensemble model is executed) and (ii) a second set of one or more models for a second timeframe in the future (e.g., a longer-term target timeframe such as the next 6 months after the date that the ensemble model is executed). In this respect, the model setup parameters obtained by the model setup component 104 may specify that the forecast window is to be parsed into the first and second timeframes for purposes of blending predicted values that are output by the different sets of models that make up the ensemble model.

A still further type of model setup parameter that may be obtained by the model setup component 104 may comprise a specification of a look-back window for the ensemble model, which defines a time window in the past for which the ensemble model's input data is to be obtained. For instance, a new ensemble model built in accordance with the present disclosure may be configured to receive input data for a time window in the past that takes the form of (i) a rolling window of a fixed length of time (e.g., a 6-month or 12-month look-back window), or (ii) an expandable look-back window that may extend back to the earliest available time for which input data is available for the new ensemble model, among other possibilities.

The model setup parameters that are obtained by the model setup component 104 may take various other forms as well.

Further, the model setup component 104 may obtain the model setup parameters in any of various manners. As one possibility, the model setup component 104 may obtain at least some of the model setup parameters via a GUI that enables a user to specify values for certain model setup parameters by typing or otherwise entering the values into the GUI, selecting the values for the model setup parameters from a list of available options that are presented via the GUI, or uploading a data file that contains the values for the model setup parameters, among other possible ways that a user may input model setup parameters via a GUI. In this respect, the model setup component 104 may cause a client device 110 associated with a user to present the GUI for specifying the values for certain model setup parameters and may then receive setup data from the client device 110 that includes values for certain model setup parameters, among other possible ways that the model setup component 104 may obtain model setup parameters via a GUI.

As another possibility, the model setup component 104 may obtain at least some of the model setup parameters by loading those model setup parameters from the data storage layer of the back-end computing platform 102 (or perhaps some other data store). For instance, the disclosed time-series forecasting tool may allow certain model setup parameters to be defined in advance, and those predefined model setup parameters may then be stored in the data storage layer of the back-end computing platform 102 (or perhaps some other data store) such that they are available to be loaded by the model setup component 104 at the time that the disclosed time-series forecasting tool is used to set up and build a new ensemble model. In this respect, the model setup component 104 could be configured to load the predefined model setup parameters by default, or the model setup component 104 could be configured to load the predefined model setup parameters in response to receiving setup data from a client device 110 indicating that a user has requested to use predefined model setup parameters. For example, the GUI for specifying model setup parameters could enable a user to select a “default model setup parameters” option, and if the setup data received from the user's client device 110 indicates that the user has selected this option, the model setup component 104 may load a default set of predefined model setup parameters from the data storage layer of the back-end computing platform 102. Or as another example, the GUI for specifying model setup parameters could enable a user to select between multiple different sets of predefined model setup parameters (e.g., multiple different model setup profiles), and if the setup data received from the user's client device 110 indicates that the user has selected one of these sets, the model setup component 104 may load the selected set of predefined model setup parameters from the data storage layer of the back-end computing platform 102. Other examples are possible as well.

The function of obtaining the model setup parameters for the new ensemble model may take various other forms as well.

Further, it is possible that at least some of the model setup parameters for the new ensemble model could be hardcoded into the server-side software 103 for the disclosed time-series forecasting tool, in which case such model setup parameters need not be obtained by the model setup component 104 prior to building the new ensemble model. For instance, as one possible implementation, the model setup parameters specifying the time resolution, the forecast window, the forecasting sub-windows, and the look-back window for the new ensemble model may each be hardcoded into the server-side software 103 for the disclosed time-series forecasting tool, whereas the model setup parameters specifying the target time-series variable and the one or more influencing variables (if any) may be obtained by the model setup component 104. Many other implementations are possible as well.

Notably, the model setup parameters for the new ensemble model may serve to define the input and output features for the new ensemble model. For instance, as a starting point, the ensemble model may have at least a first input feature comprising a sequence of past values for the target time-series variable that are from the look-back window for the new ensemble model, where this input feature is defined based on model setup parameters specifying the target time-series variable, the time resolution, and the look-back window for the new ensemble model.

Further, to the extent that one or more influencing variables have been defined for the new ensemble model, then the new ensemble model may have an additional input feature corresponding to each such influencing variable that comprises (i) a sequence of past values for the influencing variable that are from the look-back window for the new ensemble model and (ii) a sequence of future values for the influencing variable that are from the forecast window for the new ensemble model (e.g., future values that are predicted by a subject matter expert, predicted by a separate time-series model, or the like), where each of these input features is defined based on model setup parameters specifying the one or more influencing variables, the time resolution, the look-back window, and the forecast window for the new ensemble model.

Further yet, the new ensemble model may have an output feature comprising a sequence of future values for the target time-series variable that are for the forecast window, where this output feature is defined based on model setup parameter specifying the target time-series variable, the time resolution, and the forecast window for the new ensemble model.

The input and output features for the new ensemble model may take various other forms as well.

As described above, in addition to obtaining the model setup parameters, the model setup component 104 may also obtain source data for use in building the new ensemble model, which may generally comprise any data that is utilized by the model building component 105 during the process of building the new ensemble model. This source data may take various forms.

For instance, one type of source data that may be obtained by the model setup component 104 may comprise historical data for the target time-series variable that is to be forecast by the new ensemble model (which as noted above is one of the model setup parameters that may be obtained by the model setup component 104). This obtained historical data for the target time-series variable could have any of various time resolutions and be from any of various historical time windows. To illustrate with one representative example, if the target time-series variable that is to be forecast by the new ensemble model is the number of calls received by a call center related to a given unit of a business organization, the historical data that is obtained for the target time-series variable may comprise monthly counts of calls received by the call center related to the given business unit from the past 10 years. However, the target time-series variable, the time resolution, and the historical time window could each take any of various other forms as well.

Another type of source data that may be obtained by the model setup component 104 may comprise historical data for any one or more influencing variables that are to serve as input(s) to the new ensemble model (which as noted above is another one of the model setup parameters that may be obtained by the model setup component 104). As with the obtained historical data for the target time-series variable, this obtained historical data for the one or more influencing variables could have any of various time resolutions and be from any of various historical time windows. To illustrate with one representative example, if the target time-series variable that is to be forecast by the new ensemble model is the number of calls received by a call center related to a given unit of a business organization and the new ensemble model is also set up to use the number of transactions related to the given unit of the business organization as one given influencing variable, the historical data that is obtained for the given influencing variable may comprise monthly counts of transactions related to the given business unit from the past 10 years. However, the target time-series variable, the time resolution, and the historical time window could each take any of various other forms as well.

Yet another type of source data that may be obtained by the model setup component 104 may comprise historical data for any one or more offset variables that are to be backed out of or added into the target time-series variable in order to normalize (or “clean”) the values for the target time-series variable. As with the obtained historical data for the target time-series variable and the one or more influencing variables, this obtained historical data for the one or more offset variables could have any of various time resolutions and be from any of various historical time windows.

To illustrate with one representative example, if the target time-series variable that is to be forecast by the new ensemble model is the number of calls received by a call center related to a given unit of a business organization, then the offset data may comprise values for any one or more offset variables that are used to normalize the historical number of calls received by the call center related to the given business unit, such as an offset variable indicating the number of calls attributable to a random event that is not expected to occur in the future and should be backed out from the number of received calls (e.g., a natural disaster, a pandemic, etc.), an offset variable indicating the number of calls attributable to a certain type of call that should be backed out from the number of received calls (e.g., calls handled by an automated system rather than a human agent), and/or an offset variable indicating the number of calls attributable to a certain type of call that that was not accounted for in the historical number of received calls but should be added into the historical number of received calls (e.g., call backs from customers due to previous long wait time), among other possible examples of offset variables that may be used to normalize the historical values of the target time-series variable. Many other examples are possible as well.

The source data for use in building the new ensemble model that is obtained by the model setup component 104 may take various other forms as well.

Further, the model setup component 104 may obtain the source data in any of various manners. As one possibility, the model setup component 104 may obtain at least some of the source data via a GUI that enables a user to input source data for use in building the new ensemble model by typing the source data into the GUI, selecting source data from a list of available options that are presented via the GUI, or uploading a data file that contains the source data, among other possible ways that a user may input source data via a GUI. In this respect, the model setup component 104 may cause a client device 110 associated with a user to present the GUI for inputting source data and may then receive user-input source data from the client device 110, among other possible ways that the model setup component 104 may obtain source data via a GUI.

As another possibility, the model setup component 104 may obtain at least some of the source data by accessing and loading such source data from the data storage layer of the back-end computing platform 102 (or perhaps some other data store). In this respect, the model setup component 104 could be configured to access and load the source data in response to receiving setup data from a client device 110 indicating a user's specification of any one or more variables for which source data is to be obtained, such as the target time-series variable, an influencing variable, or an offset variable. For example, after receiving model setup data from the client device 110 indicating that a user has specified the target time-series variable to be forecast by the new ensemble model, the model setup component 104 may locate historical values for the target time-series variable within the data storage layer of the back-end computing platform 102 (or perhaps some other data store) and then load those historical values for the target time-series variable. As another example, after receiving model setup data from the client device 110 indicating that a user has specified a given influencing variable that is to serve as an input to the new ensemble model, the model setup component 104 may locate historical values for the given influencing variable within the data storage layer of the back-end computing platform 102 (or perhaps some other data store) and then load those historical values for the target time-series variable. As yet another example, after receiving model setup data from the client device 110 indicating that a user has specified a given offset variable to apply to the target time-series variable, the model setup component 104 may locate historical values for the given offset variable within the data storage layer of the back-end computing platform 102 (or perhaps some other data store) and then load those historical values for the target time-series variable. Other examples are possible as well.

As yet another possibility, the model setup component 104 may obtain at least some of the source data by requesting and receiving it from a third-party data source.

The function of obtaining the source data for use in building the new ensemble model may take various other forms as well.

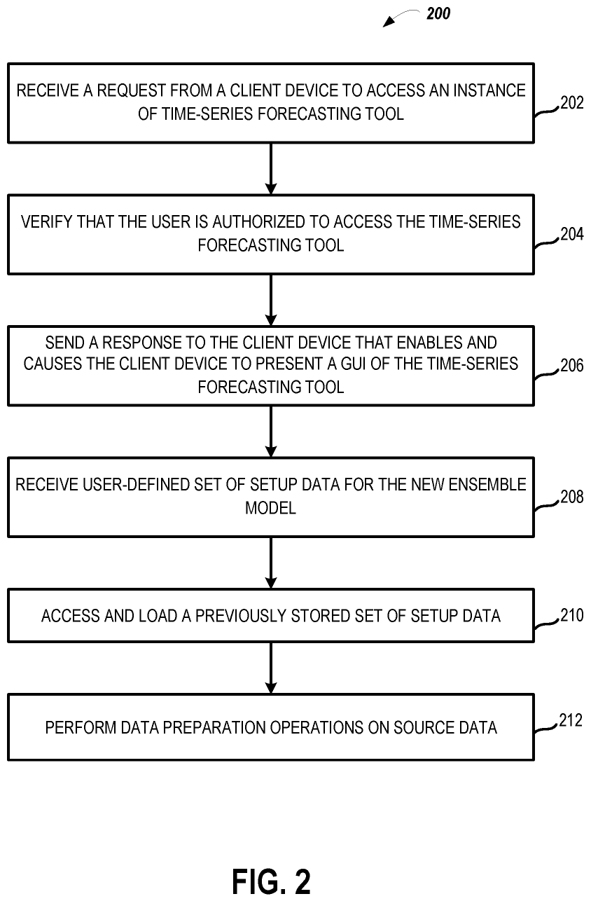

The functionality that is carried out by the back-end platform 102 installed with the model setup component 104 of the server-side software 103 in order to obtain and prepare setup data that is to be utilized by the model building component 105 during the process of building a new ensemble model may take any of various forms, and one possible implementation of that functionality is illustrated in FIG. 2. For purposes of illustration, the example functionality 200 of FIG. 2 is described as being carried out by the back-end computing platform 102 of FIG. 1 that is installed with the model setup component 104, but it should be understood that the example functionality of FIG. 2 may be carried out by any computing platform that is capable of running the software disclosed herein. Further, it should be understood that the example functionality of FIG. 2 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular embodiment.

As shown in FIG. 2, the example functionality 200 may begin at block 202 with the back-end computing platform 102 receiving a request from a client device 110 to access an instance of the disclosed time-series forecasting tool. In practice, this request may take the form of one or more request messages (e.g., one or more HTTP messages) that are sent over the respective communication path between the client device 110 and the back-end computing platform 102 (which as noted above may include at least one data network), and in at least some implementations, the one or more request messages may be sent via an API. The request to access the time-series forecasting tool may take other forms and/or be received in other manners as well. Further, the request that is received from the client device 110 may include identifying information and/or security credentials (e.g., a username and password, a security token, etc.) for the user, among other possible information that may be included in the request.

At block 204, after receiving the request to access the time-series forecasting tool, the back-end computing platform 102 may optionally verify that the user has authorization to access the time-series forecasting tool. The function of verifying that the user has authorization to access the time-series forecasting tool may be carried out using any authentication and/or authorization technology now known or later developed.

At block 206, after receiving the request to access the time-series forecasting tool (and optionally verifying that the user has authorization to access the time-series forecasting tool), the back-end computing platform 102 may send a response to the client device 110 that enables and causes the client device 110 to run client-side software for the time-series forecasting tool. In practice, this request may take the form of one or more response messages (e.g., one or more HTTP messages) that are sent over the respective communication path between the back-end computing platform 102 and the client device 110 (which as noted above may include at least one data network), and in at least some implementations, the one or more response messages may be sent via an API. Further, the response that is sent to the client device 110 may comprise instructions and data for presenting a GUI of the time-series forecasting tool that can be utilized to input setup data for the new ensemble model, which the client device 110 may utilize to present the GUI of the time-series forecasting tool to the user. This GUI may be referred to herein as the “model setup GUI” of the time-series forecasting tool.

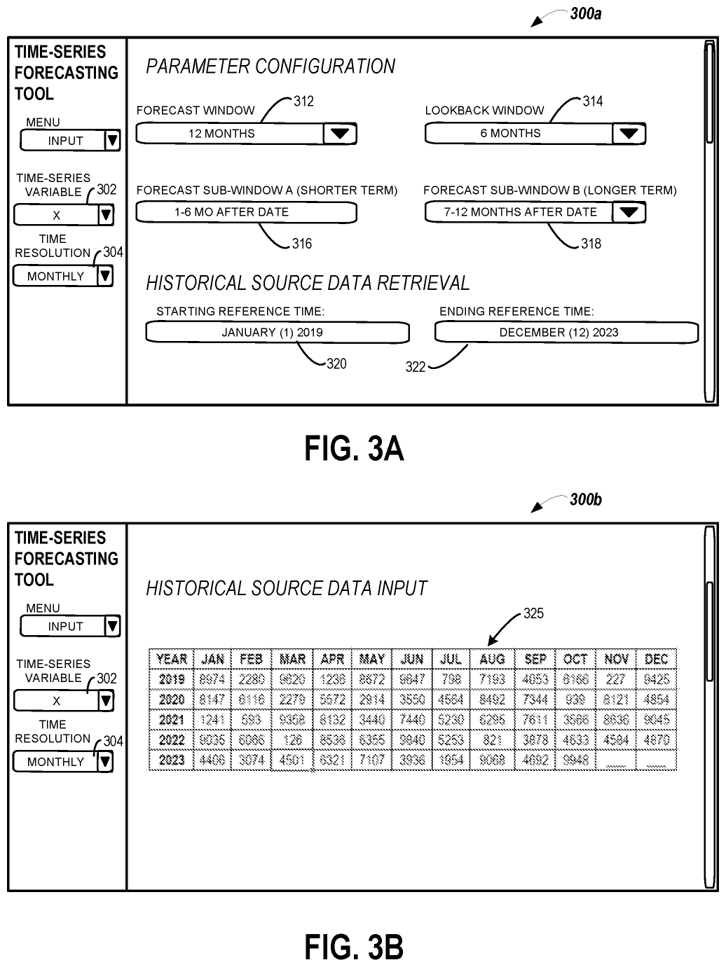

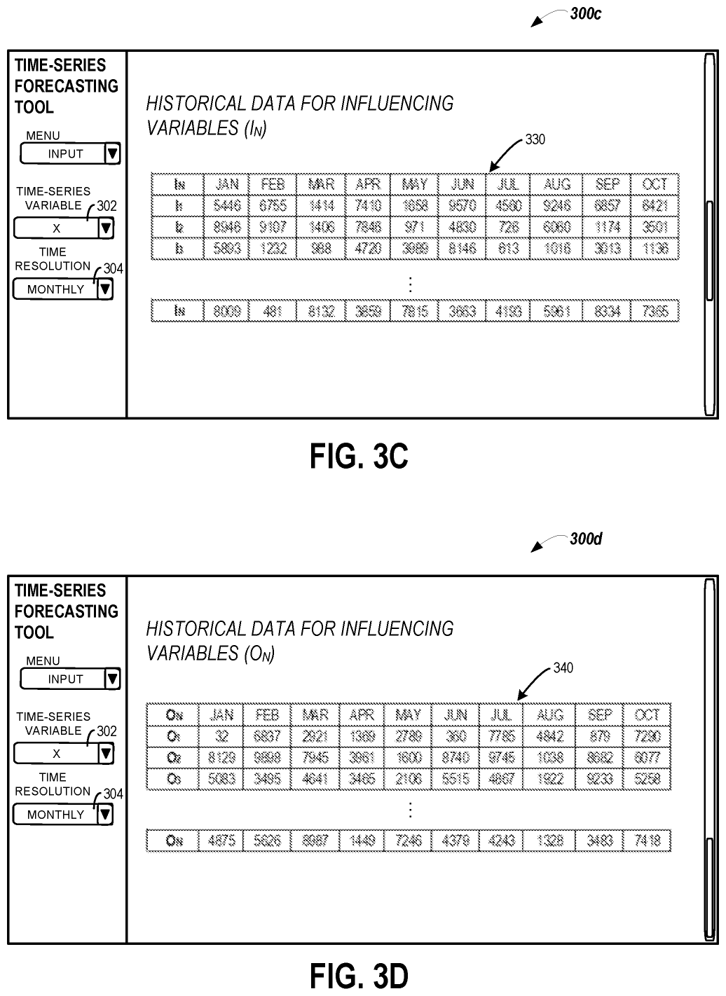

In accordance with the present disclosure, the model setup GUI of the time-series forecasting tool that is presented by the client device 110 may include various GUI input elements (e.g., buttons, text input fields, dropdown lists, slider bars, etc.) that enable the user to input setup data for the new ensemble model. For instance, in line with the discussion above, the model setup GUI of the time-series forecasting tool that is presented by the client device 110 may include GUI input elements that enable the user to input (i) certain model setup parameters for the new ensemble model, examples of which may include a target time-series variable to be forecast by the new ensemble model, one or more influencing variables, one or more offset variables, a time resolution, a forecast window along with forecast sub-windows for blending, and/or a look-back window, and perhaps also (ii) certain source data for use in building the new ensemble model, examples of which may include historical data for the target time-series variable to be forecast by the new ensemble model, historical data for one or more influencing variables, and/or historical data for one or more offset variables. Some representative examples of GUI elements and user input that may be utilized to input setup data new ensemble model are described in further detail below with reference to FIGS. 3A-3D.

After the client device 110 presents the model setup GUI of the time-series forecasting tool, the user may utilize the model setup GUI of the time-series forecasting tool to input setup data for the new ensemble model. For example, the user may use the model setup GUI to input certain model setup parameters by typing the values into the model setup GUI, selecting the values for the model setup parameters from a list of available options that are presented via the model setup GUI, or uploading a data file that contains the values for the model setup parameters, among other possible ways that a user may input model setup parameters via a GUI. As another example, the user may use the model setup GUI to input source data by typing or otherwise entering the source data into the model setup GUI, selecting source data from a list of available options that are presented via the model setup GUI, or uploading a data file that contains the source data, among other possible ways that a user may input source data via a GUI.

Based on the user input, the client device 110 may send a user-defined set of setup data for the new ensemble model to the back-end computing platform 102, and at block 208, the back-end computing platform 102 may receive the user-defined set of setup data for the new ensemble model. In practice, this user-defined set of setup data may be contained within one or more request messages (e.g., one or more HTTP messages) that are sent over the respective communication path between the client device 110 and the back-end computing platform 102 (which as noted above may include at least one data network), and in at least some implementations, the one or more request messages may be sent via an API. For instance, in some implementations, the full user-defined set of setup data may be contained within a single request message, whereas in other implementations, the user-defined set of setup data may be divided across multiple request messages (e.g., one message containing model setup parameters and one or more other messages containing source data). The user-defined setup data for the new ensemble model may take other forms and/or be received in other manners as well.

At block 210, the back-end computing platform 102 may additionally access and load a previously-stored set of setup data for the new ensemble model from the data storage layer of the back-end computing platform 102 (or perhaps some other data store). For example, if the user-defined set of setup data for the new ensemble model includes a specification of the target time-series variable to be forecast by the ensemble model but does not include any historical data for the target time-series variable, the back-end computing platform 102 may access and load a previously-stored historical dataset for the target time-series variable. As another example, if the user-defined set of setup data for the new ensemble model includes a specification of a given influencing variable for the new ensemble model but does not include any historical data for the given influencing variable, the back-end computing platform 102 may access and load a previously-stored historical dataset for the given influencing variable. As yet another example, if the user-defined set of setup data for the new ensemble model includes a specification of a given offset variable for normalizing the target time-series variable but does not include any historical data for the given offset variable, the back-end computing platform 102 may access and load a previously-stored historical dataset for the given influencing variable. The function of accessing and loading a previously-stored set of setup data for the new ensemble model from the data storage layer of the back-end computing platform 102 (or perhaps some other data store) may take other forms as well-including but not limited to the possibility that certain model setup parameters for the new ensemble model could be accessed and loaded from the data storage layer of the back-end computing platform 102 (or perhaps some other data store) rather than being specified by the user via the model setup GUI.

In line with the discussion above, it should also be understood that certain model setup parameters for the new ensemble model could be hardcoded into the server-side software 103 for the disclosed time-series forecasting tool rather than being specified by the user via the model setup GUI or accessed and loaded from a data store.

At block 212, after obtaining the source data for use in building the new ensemble model in one or more of the manners described above, the back-end computing platform 102 also may optionally perform certain data preparation operations on the source data (if necessary) in order to place the source data into a form that can be used to define the training and validation datasets. These data preparation operations could take any of various forms.

For instance, to the extent that the obtained source data includes historical data having a different time resolution than the defined time resolution for the given ensemble model, one type of data preparation operation performed by the back-end computing platform 102 may involve resampling certain portions of the obtained historical data in order to align the time resolutions of the historical data. For example, if the historical values for the target time-series variable, a given influencing variable, and/or a given offset variable have a different time resolution than the defined time resolution for the new ensemble model, then the back-end computing platform 102 may down-sample (e.g., via aggregation) or up-sample (e.g., via interpolation) the historical values for the target time-series variable, a given influencing variable, and/or a given offset variable in order to align the time resolution of that historical data with the defined time resolution of the ensemble model. Other examples are possible as well.

Further, to the extent that the obtained source data includes historical data for any one or more offset variables, another type of data preparation operation performed by the back-end computing platform 102 may involve normalizing the historical data for the target time-series variable based on the historical data for the one or more offset variables so as to produce an updated historical dataset (i.e., a “normalized” or “baseline” historical dataset) for the target time-series variable. For example, if the source data includes historical data for an offset variable that is to be backed out of the target time-series variable, then the back-end computing platform 102 may decrease the historical values of the target time-series variable based on the historical values of the offset variable. As another example, if the source data includes historical data for an offset variable that is to be added into the target time-series variable, then the back-end computing platform 102 may increase the historical values of the target time-series variable based on the historical values of the offset variable. Other examples may be possible as well.

Further yet, another type of data preparation operation performed by the back-end computing platform 102 may involve removing outliers from the source data.

The data preparation operations that may optionally be performed by the back-end computing platform 102 on the source data that was received via the setup GUI and/or accessed and loaded from the data storage layer may take various other forms as well.

The functionality that is carried out by the back-end computing platform 102 installed with the model setup component 104 in order to obtain prepare the setup data that is to be utilized by the model building component 105 during the process of building a new ensemble model could take other forms as well.

Turning now to FIGS. 3A-3D, some example GUI views for setting up the ensemble model, via receipt of input for the model setup parameters and/or training data, in accordance with the present disclosure are illustrated. For instance, FIG. 3A illustrates an example first GUI view 300a comprising input elements that enable a user to input model setup parameters and/or indicate source data for the ensemble model, which is then received as input by the back-end computing platform 102.

As shown, the first GUI view 300a may include a set of input elements (e.g., fillable text fields, dropdown lists, etc.) that enable the user to input setup parameters for input to the back-end computing platform 102 via the functionality of the model setup component 104. For example, the first GUI view 300a may include one or more input fields for inputting model setup parameters, such as, but not limited to, (i) a time-series variable input field 302 that provides a field for a user to indicate a time-series variable for which a user requests one or more forecast values, (ii) a time resolution input element 304 that provides a field for a user to indicate a time resolution for a given ensemble model, (iii) forecast window input element 312 that provides a field for a user to indicate a time window in which the user desires forecast values for the time-series variable (e.g., the time-series variable input at the time-series variable input field 302), (iv) a shorter-term forecast sub-window input field 316 that provides a field for a user to indicate a forecast window for one or more shorter-term time-series models, and (v) a longer-term forecast sub-window input field 318 that provides a field for a user to indicate a forecast window for one or more longer-term time-series models.

In the example of FIG. 3A, the first GUI view 300a may present a user of a client device 110 with beginning and ending date training data input fields 320, 322, wherein the beginning date training data input field 320 receives an indication from a user of the client device 110 for a starting time, in a time-series, from which to retrieve training data values of a target time-series variable for input as the training data. The ending date training data input field 322 receives input for an ending time, in a time-series, from which to retrieve training data values of a target time-series variable for input as the training data.

FIG. 3B illustrates an example second GUI view 300b comprising a target variable input element 325, which may be utilized, by a user via a client device 110, to input and/or edit values for a target time-series variable that are intended for use in training the ensemble model. As illustrated, the target variable data input element 322 may take the form of a text or numeral input table, such as a spreadsheet, but other input elements suitable for inputting time-series variable values are certainly possible.

FIG. 3C illustrates an example third GUI view 300c comprising an influencing variable input element 330 that enables a user to input and/or edit values for any influencing variables that are intended for use in training the ensemble model. As illustrated, the influencing variable input element 330 may take the form of a text or numeral input table, such as a spreadsheet, but other input elements suitable for inputting time-series variable values are certainly possible.

FIG. 3D illustrates an example fourth GUI view 300d comprising an offset data input element 340 that enables a user to input and/or edit values for any offset data variables that are intended for use in training the ensemble model. As illustrated, the offset data input element 340 may take the form of a text or numeral input table, such as a spreadsheet, but other input elements suitable for inputting time-series variable values are certainly possible.

In some examples, after the model setup data is obtained by the back-end computing platform 102 installed with the model setup component 104, the back-end computing platform 102 may further carry out functionality for performing model assumption testing. Model assumption testing refers to one or more tests to (i) evaluate whether model setup parameters received via the model setup component 104 are suitable for training the types of time-series models that are to be generated by the model building component 105, and/or (ii) evaluate whether the source data received via the model setup component 104 is suitable for use in training the types of models that are to be generated by the model building component 105. For example, in performing model assumption testing, the back-end computing platform 102 may carry out functionality to execute one or more automated tests on the preconditions of different potential time-series models, wherein the model setup parameters and/or source data are subject to the one or more automated tests. Such tests may include, but are not limited to including, stationarity tests, multicollinearity tests, among other tests for determining at least one time-series model characteristic that may affect suitability of a time-series model. If one or more of the tests for model assumption testing, based on an analysis of one or both of the model setup parameters or the source data, produces a result that indicates that the preconditions of a potential time-series model are unsuitable for training a time-series model of a given time-series model type, then a user of a client device 110 who is using the time-series forecasting tool may be alerted as to the unsuitability via some indication. The indication may be, for example, an alert presented via a GUI on a client device 110 indicating that the model setup parameters and/or source data may not be suitable for training a time-series model of a given time-series model type.

Referring back to FIG. 1, at a high level, the model building component 105 of the server-side software 103 may cause the back-end computing platform 102 to carry out functionality for building a new ensemble model that is configured to forecast time-series data. At a high level, this functionality may involve (i) generating different sets of time-series models that are configured to forecast values of a time-series variable for different timeframes in the future, which may be referred to herein as “target timeframes,” (ii) causing a user to be presented with a GUI for configuring a new ensemble model that is comprised of a selected subset of the generated time-series models, (iii) receiving configuration parameters for the new ensemble model, which may include an identification of which time-series models to include in the ensemble model and corresponding weights for at least some of the identified time-series models, and (iv) based on the received configuration parameters, constructing an ensemble model that is configured to blend the forecast values of the time-series variable that are output by the identified time-series models.

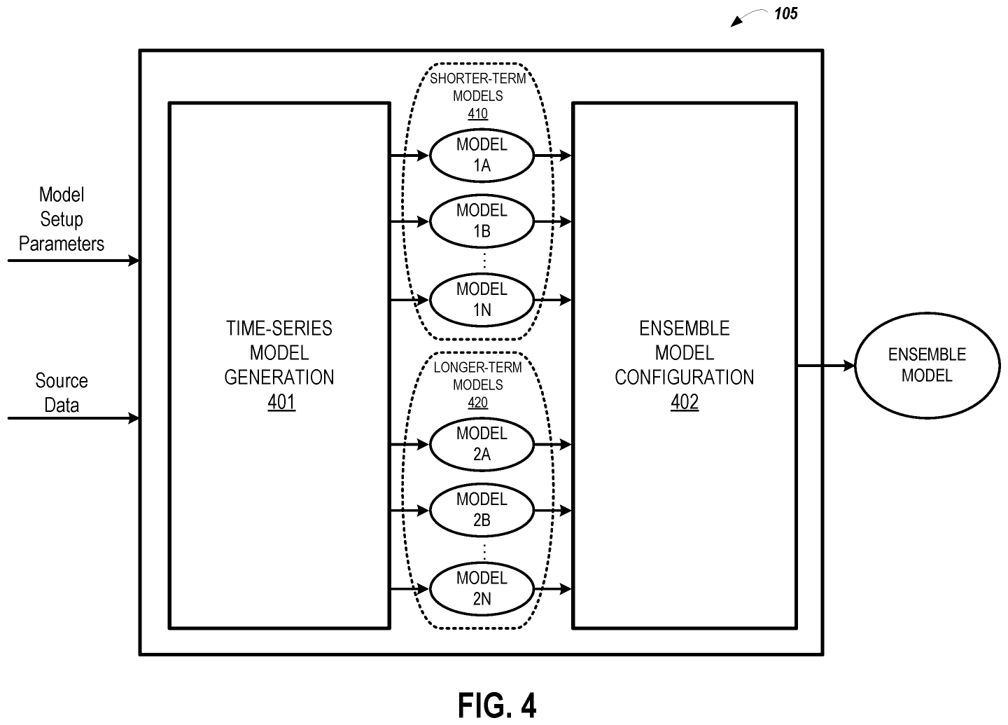

FIG. 4 depicts a conceptual illustration of one example embodiment of the model building component 105, which is shown to include a time-series model generation sub-component 401 and an ensemble model configuration sub-component 402. However, it should be understood that the model building component 105 could take various other forms as well.

In the example embodiment of FIG. 4, the time-series model generation sub-component 401 may function to generate at least two sets of time-series models that are configured to forecast values for a target time-series variable: (i) a first set of time-series models 410 that are each configured to forecast values of the target time-series variable for a shorter-term target timeframe, which are labeled in FIG. 4 as Model 1A, Model 1B, . . . Model 1N, and (ii) a second set of time-series models 420 that are each configured to forecast values of the target time-series variable for a longer-term target timeframe, which are labeled in FIG. 4 as Model 2A, Model 2B, . . . Model 2N. In general, the terms “shorter-frame target timeframe” and “longer-term target timeframe” may refer to any two target timeframes where one of the timeframes begins earlier in time and the other one of the timeframes ends later in time. To illustrate with one possible implementation, each time-series model in the first set of time-series models 410 may be configured to forecast values of the target time-series variable for a shorter-term target timeframe that spans an earlier window of time after the date the time-series model is run (e.g., the first 6 months after the time-series model is run), and each time-series model in the second set of time-series models 420 may be configured to forecast values of the target time-series variable for a longer-term target timeframe that begins at (or after) the point that the earlier window of time ends and spans a later window of time (e.g., the next 6 months after the time-series model is run). For example, if a time-series model is run on Jan. 1, 2024, then the shorter-term target timeframe could comprise a 6-month window of time that begins on Jan. 1, 2024 and extends to Jul. 1, 2024 and the longer-term target timeframe could comprise a 6-month window of time that begins on Jul. 1, 2024 (when the shorter-term target timeframe ends) and extends to Jan. 1, 2025.

However, it should be understood that the shorter-term and longer-term target timeframes covered by the first and second sets of time-series models 410, 420 could take various other forms as well, including but not limited to the possibility that (i) the shorter-term and longer-term target timeframes could each have any of various lengths, (ii) the shorter-term target timeframe could start on date that differs from when the time-series model is run, and/or (iii) the longer-term target timeframe could start on date that differs from when the shorter-term target timeframe ends.

Additionally, it should be understood that FIG. 4 merely illustrates one possible embodiment of the of the model building component 105, and that in other embodiments, the model building component 105 may function to generate sets of time-series models for other timeframes. For instance, in one alternate embodiment, the model building component 105 may function to generate (i) a first set of time-series models that are each configured to forecast values of the target time-series variable for a shorter-term target timeframe, (ii) a second set of time-series models that are each configured to forecast values of the target time-series variable for a medium-term timeframe (e.g., a timeframe that begins when the shorter-term target timeframe ends and then ends before the longer-timeframe begins), and (iii) a third set of time-series models that are each configured to forecast values of the target time-series variable for a longer-term target timeframe (e.g., a timeframe that begins when the medium-term timeframe ends). Other embodiments are possible as well.

Further, in operation, the shorter-term and longer-term target timeframes covered by the first and second sets of time-series models 410, 420 could be either defined based on the setup data that is obtained by the model setup component 104 (e.g., model setup parameters specifying the forecast window and corresponding forecast sub-windows for blending) or hardcoded into the server-side software 103 of the disclosed time-series forecasting tool, among other possibilities. And along similar lines, the time resolution of the values to be forecast by the first and second sets of time-series models 410, 420 in the shorter-term and longer-term target timeframes could be either defined based on the setup data that is obtained by the model setup component 104 (e.g., a model setup parameter specifying the time resolution of the new ensemble model) or hardcoded into the server-side software 103 of the disclosed time-series forecasting tool, among other possibilities.

Further yet, the time-series models that are included in each respective set of time-series models 410, 420 generated by the time-series model generation sub-component 401 may differ from one another in terms of the type of time-series model and/or the hyperparameters of the time-series model, among other possible model parameters that may differ between time-series models within the same set of time-series models generated by the time-series model generation sub-component 401. In this respect, the types of time-series models included in the respective sets of time-series models 410, 420 generated by the time-series model generation sub-component 401 could take any of various forms, examples of which may include an Autoregressive Integrated Moving-Average (ARIMA) type of time-series model, a Seasonal Autoregressive Integrated Moving-Average with exogenous regressors (SARIMAX) type of time-series model, an Unobserved Components type of time-series model, an Exponential Smoothing type of time-series model, a Prophet type of time-series model, a Generalized AutoRegressive Conditional Heteroskedasticity (GARCH) type of time-series model, a Vector Autoregression type of time-series model, a Long Short-term Memory (LSTM) network type of time-series model, and other neural network types of time-series models, among other possible examples. Further, the hyperparameters for the time-series models included in the respective sets of time-series models 410, 420 generated by the time-series model generation sub-component 401 could be determined using any of various hyperparameter tuning techniques (or sometimes referred to as “hyperparameter optimization” techniques), including but not limited to a grid search or randomized search technique, among other possible as examples.

According to one possible implementation, each respective set of time-series models 410, 420 generated by the time-series model generation sub-component 401 may include one time-series model per available type of time-series model, where each such time-series model has a set of hyperparameters that have been tuned relative to at least one other candidate time-series model of that same type. To illustrate with an example, each respective set of time-series models generated by the time-series model generation sub-component 401 could include a first time-series model of a first type (e.g., a SARAMAX model) that has a first set of hyperparameters which are tuned for the first type of time-series model, a second time-series model of a second type (e.g., an Unobserved Components model) that has a second set of hyperparameters which are tuned for the second type of time-series model, and so on for any other available type of time-series model that can be generated by the time-series model generation sub-component 401. However, the respective sets of time-series models generated by the time-series model generation sub-component 401 could take various other forms as well, including but not limited to the possibility that (i) a given set of time-series models could be generated to include multiple time-series models that are of the same type but have different hyperparameters, and/or (ii) different sets of time-series models could include different types of time-series models.

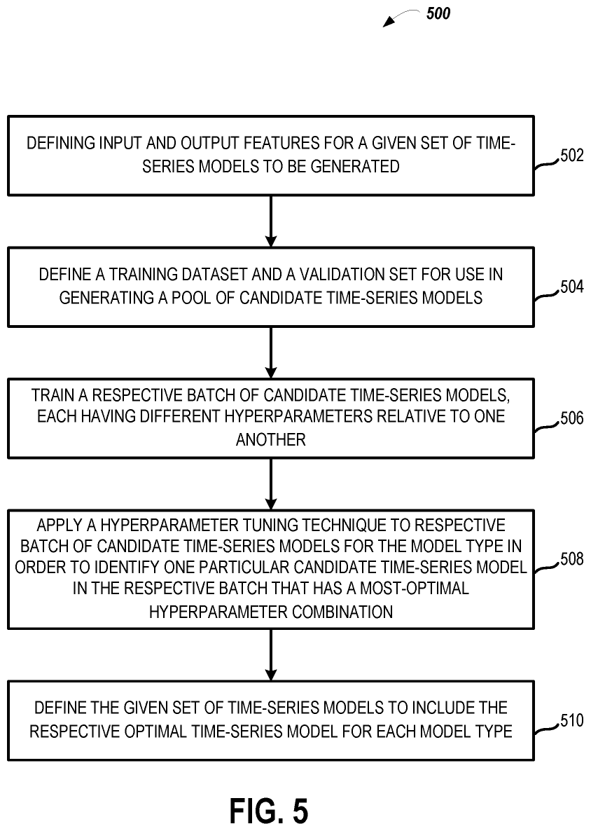

The functionality that is carried out by the back-end computing platform 102 installed with the time-series model generation sub-component 401 in order to generate a given set of time-series models may take any of various forms, and one possible implementation of that functionality is illustrated in FIG. 5. For purposes of illustration, the example functionality 500 of FIG. 5 is described as being carried out by the back-end computing platform 102 of FIG. 1 that is installed with the model building component 105, but it should be understood that the example functionality of FIG. 5 may be carried out by any computing platform that is capable of running the software disclosed herein. Further, it should be understood that the example functionality of FIG. 5 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular embodiment.

As shown in FIG. 5, the example functionality 500 may begin at block 502 with the back-end computing platform 102 defining input and output features for the given set of time-series models to be generated. In this respect, the input and output features of the given set of time-series models to be generated may be defined based on the model setup parameters that are obtained by the model setup component 104 and/or hardcoded into the server-side software 103 of the disclosed time-series forecasting tool and the timeframe for which given set of time-series models is to be generated, among other possibilities.

For instance, as a starting point, the time-series models to be generated may have at least a first input feature comprising a sequence of past values for the target time-series variable that are from the look-back window for the new ensemble model, which as noted above could take the form of a fixed window (e.g., the prior 12 months) or an expandable window. In practice, this input feature may be defined based on model setup parameters specifying the target time-series variable, the time resolution, and the look-back window for the new ensemble model.

Further, to the extent that one or more influencing variables have been defined for the new ensemble model, the time-series models to be generated may have an additional input feature corresponding to each such influencing variable that comprises (i) a sequence of past values for the influencing variable that are from the look-back window for the new ensemble model and (ii) a sequence of future values for the influencing variable that are from the target timeframe of the given set of the time-series models (e.g., the shorter-term target timeframe for the first set of time-series models or the longer-term target timeframe for the second set of time-series models). In practice, each of these input features may be defined based on model setup parameters specifying the one or more influencing variables, the time resolution, and the look-back window for the new ensemble model as well as the target timeframe for the given set of time-series models.

Further yet, the time-series models to be generated may have an output feature comprising a sequence of future values for the target time-series variable that are for the target timeframe of the given set of the time-series models (e.g., the shorter-term target timeframe for the first set of time-series models or the longer-term target timeframe for the second set of time-series models). In practice, the output feature may be defined based on model setup parameters specifying the target time-series variable and the time resolution for the new ensemble model as well as the target timeframe for the given set of time-series models.

The input and output features for the given set of time-series models to be generated may take various other forms as well.

At block 504, the back-end computing platform 102 may define different splits of training datasets and corresponding validation datasets (or sometimes called a “test datasets”) for use in generating a pool of candidate time-series models. In general, the training datasets may each comprise any dataset that can be utilized to train a pool of candidate time-series models during a training process, and the validation datasets may each comprise any dataset that can be utilized to evaluate the performance of the for the pool of candidate time-series models during a hyperparameter tuning process.

In operation, the training datasets and the validation datasets may be defined based on certain portions of the source data that were obtained and prepared by the model setup component, including historical data for the target time-series variable (which may be normalized based on the historical offset data as described above) and perhaps also historical data for one or more influencing variables.

For instance, according to one possible implementation, the back-end computing platform 102 may begin by defining reference times for splitting the historical data for the target time-series variable and any specified influencing variable(s) into the different splits of training datasets and corresponding validation datasets (e.g., in a rolling manner). For instance, if there is available historical data for the target time-series variable from January 2016 to December 2017 and the time-series model has a shorter-term target timeframe of the first 6 months, then the back-end computing platform 102 may define (i) a first reference time of January 2017 that is used to split the historical data into a first split comprising one subset from January 2016 to January 2017 that is to be used to define the training dataset and another subset from February 2017 to August 2017 that is to be used to define the validation dataset, (ii) a second reference time of February 2017 that is used to split the historical data into a second split comprising one subset from January 2016 to February 2017 that is to be used to define the training dataset and another subset from March 2017 to September 2017 that is to be used to define the validation dataset, and so on for other splits of training-validation datasets.

After defining each split's respective reference time, then for each respective split, the back-end computing platform 102 may parse the historical data for the target time-series variable and any specified influencing variable(s) into two subsets: (i) a first subset of historical data for use in defining the training dataset within the split, which may include historical data before the split's respective reference date, and (ii) a second subset of historical data for use in defining the validation dataset within the split, which may include historical data after the split's respective reference date. Other examples are possible as well.

In turn, the back-end computing platform 102 may process each subset of historical data for each respective split into “input-label pairs” that each comprise (i) an input array comprising reference data for the input feature(s) of the given set of time-series models being generated, and (ii) a corresponding label array comprising ground-truth data for the output feature of the given set of time-series models being generated that corresponds to the reference data for the input feature(s). The function of parsing a subset of historical data into input-label pairs such as these may take any of various forms.

As one possibility, the back-end computing platform 102 may iterate through different reference times that are represented within the subset of historical data, and for each such reference time, the back-end computing platform 102 may define an input array and a corresponding label array relative to the reference time. In this respect, the input array that is defined relative to the reference time may include a sequence of historical values for the target time-series variable that are from the look-back window as it is applied to the reference time (e.g., a fixed or expandable window extending back in time from the reference time). Additionally, to the extent that the given set of time-series models being generated have at least one input feature corresponding to an influencing variable, then for each such input feature, the input array that is defined relative to the reference time may include (i) a sequence of past values for the influencing variable that are from the look-back window as it is applied the reference time (e.g., a fixed or expandable window extending back in time from the reference time) and (ii) a sequence of future values for the influencing variable that are from the target timeframe of the given set of the time-series models (e.g., the shorter-term target timeframe for the first set of time-series models or the longer-term target timeframe for the second set of time-series models). In turn, the corresponding label array that is defined relative to the reference time may include a sequence of historical values for the target time-series variable that are from the target timeframe of the given set of the time-series models (e.g., the shorter-term target timeframe for the first set of time-series models or the longer-term target timeframe for the second set of time-series models).

To illustrate with one representative example, consider a scenario where (i) the subset of source data for use in defining the training dataset within a given split includes historical monthly values for the target time-series variable and any defined influencing variables(s) that were recorded for a 5-year window of time spanning from January 2016 to December 2020, (ii) the look-back window for the given set of time-series models is a 12-month window that extends back in time from the execution time of the models, and (iii) the target timeframe for the given set of time-series models is the shorter-term window of encompassing first 6 months after the execution time of the models. In this example, the back-end computing platform 102 could define a first input-label pair based on a first reference time of January 2017 that constitutes (i) an input array containing historical values for the target time-series variable from January 2016 through December 2016 and perhaps also historical values for one or more influencing variables from January 2016 through June 2017 and (ii) a corresponding label array containing historical values for the target time-series variable from January 2017 through June 2017. Likewise, the back-end computing platform 102 could define a second input-label pair based on a second reference time of February 2017 that constitutes (i) an input array containing historical values for the target time-series variable from February 2016 through January 2017 and perhaps also historical values for one or more influencing variables from February 2016 through July 2017 and (ii) a corresponding label array containing historical values for the target time-series variable from February 2017 through July 2017. And along similar lines, the back-end computing platform could iterate through numerous other reference times within the 5-year window of time spanning from January 2016 to December 2020 in order to generate numerous other input-label pairs.

Thus, as a result of this operation, the back-end computing platform 102 may produce a set of input-label pairs that constitutes either the training dataset or the validation dataset within a given split of training-validation datasets, depending on which subset of historical data is used. And the back-end computing platform 102 may then repeat this operation for the other subset of historical data so as to define both the training dataset and the validation dataset.

The function of defining the different splits of training datasets and corresponding validation datasets may take various other forms as well.

At block 506, for each of multiple different model types, the back-end computing platform 102 may train a respective batch of candidate time-series. For instance, the back-end computing platform 102 may train a first batch of candidate time-series models for a first model type (e.g., SARAMAX), a second batch of candidate time-series models for a second model type (e.g., Unobserved Components), and so on for any other available model type that is to be generated by the time-series model generation sub-component 401, where the candidate time-series models within each respective batch have different hyperparameters relative to one another.

The functionality of training a batch of candidate time-series models for a given time-series model type may take any of various forms. As one possible implementation, the functionality of training a batch of candidate time-series models for a given time-series model type may begin with the back-end computing platform 102 defining a search space of different hyperparameter combinations for the given model type. In this respect, the search space of different hyperparameter combinations could comprise a grid of all possible hyperparameter combinations for the given model type (e.g., if the time-series model generation sub-component 401 is configured to use grid search for hyperparameter tuning) or a randomly-selected sampling of possible hyperparameter combinations for the given model type (e.g., if the time-series model generation sub-component 401 is configured to use random search for hyperparameter tuning), among other possible examples of a search space of different hyperparameter combinations that could be defined for the batch of candidate time-series models.

Next, the back-end computing platform 102 may iterate through the hyperparameter combinations in the defined search space, and for each respective hyperparameter combination, the back-end computing platform 102 may generate multiple instances of a time-series model having the respective hyperparameter combination. To accomplish this for a given hyperparameter combination, the back-end computing platform 102 may run multiple instances of a training operation for the given model type (e.g., a SARAMAX training operation, Unobserved Components training operation, and/or any other training operation associated with a specific time-series model type), where each such instance uses the same given hyperparameter combination but a different training dataset (e.g., from a different split of the training-validation datasets) in order to generate a respective time-series model of the given model type that has the given hyperparameter combination. For example, in order to generate multiple instances of a time-series model of a given mode type having a first hyperparameter combination, the back-end computing platform 102 may run a first instance of a training operation for the given model type using the first hyperparameter combination and a first training dataset in order to generate a first instance of a time-series model of the given model type that has the first hyperparameter combination, a second instance of the training operation for the given model type using the first hyperparameter combination and a second training dataset in order to generate a second instance of a time-series model of the given model type that has the first hyperparameter combination, and so on for each other training dataset that is defined. Likewise, the back-end computing platform 102 may carry out similar functionality for each of the other hyperparameter combinations in the defined search space. Thus, as a result of this functionality, the back-end computing platform 102 may generate a batch of candidate time-series models for the given model type that includes respective sub-batches of time-series models for the hyperparameter combinations within the defined search space (e.g., a first sub-batch of time-series models for a first hyperparameter combination, a second sub-batch of time-series models for a second hyperparameter combination, etc.).

However, in other embodiments, it is also possible that the back-end computing platform 102 could generate a single candidate time-series model for each hyperparameter combination, such as in a scenario where there is only a single training dataset.

The back-end computing platform 102 may carry out similar functionality for each of the other model types for which time-series models are generated, thereby resulting in the generation of a respective batch of time-series models for each such model type.

At block 508, for each of the multiple different model types, the back-end computing platform 102 may apply a hyperparameter tuning technique to the respective batch of candidate time-series models for the model type in order to identify one particular candidate time-series model in the respective batch that has a most-optimal hyperparameter combination, which may be referred to as the “optimal” time-series model for the model type.

At a high level, the functionality of applying a hyperparameter tuning technique to a generated batch of candidate time-series models for a given model type may generally involve (i) for each respective hyperparameter combination, evaluating the performance of the instances of a time-series model having the respective hyperparameter combination using the validation datasets that correspond to the training datasets used to generate the instances of the time-series model (e.g., from the splits of training-validation datasets) and then determining a respective measure of performance for the respective hyperparameter combination, (ii) identifying a particular one of the hyperparameter combinations that delivers the best performance (e.g., the candidate time-series model that most accurately forecasts the values of the target time-series variable), and (iii) selecting a candidate time-series model having the identified hyperparameter combination as the optimal time-series model for the model type. This functionality may take any of various forms.

For instance, as one possible implementation, the functionality of evaluating the performance of the instances of a time-series model having a given hyperparameter combination using the validation datasets that correspond to the training datasets used to generate the instances of the time-series model may involve the following functionality for each respective instance of the time-series model and its corresponding validation dataset: (i) for each validation input-label pair, inputting the pair's input array into the respective instance of time-series model and thereby causing the respective instance of the time-series model to output a respective prediction comprising a forecasted sequence of values for the target time-series variable, (ii) for each validation input-label pair, performing a comparison between the respective prediction output by the respective instance of the time-series model and the pair's label array (which as noted above contains a sequence of ground-truth values for the target time-series variable), and (iii) based on the comparisons performed across the different validation input-label pairs, deriving a respective instance-specific measure of the performance of the respective instance of the time-series model. In this respect, the respective instance-specific measure of the performance of each respective instance of the time-series model having the given hyperparameter combination could take any of various forms, examples of which may include a mean absolute percentage error (MAPE), a weighted mean absolute percentage error (WMAPE), symmetric mean absolute percentage error (SMAPE), or Normalized Mean Absolute Error (NMAE), mean absolute deviation (MAD), mean absolute error (MAE), mean squared error (MSE), or root mean squared error (RMSE), among other possible examples of metrics that quantify the performance of a time-series model.

To illustrate with a simplified example, consider a scenario where a validation dataset for a given instance of a time-series model includes three validation input-label pairs. In such an example, the back-end computing platform 102 may (i) input the input arrays of the three validation input-label pairs into the given instance of the time-series model and thereby cause the given candidate time-series model to output three predictions, each comprising a forecasted sequence of values for the target time-series variable, (ii) for each the three validation input-label pairs, performing a comparison between the respective prediction output by the given instance of the time-series model and the label array of the input-label pair, and (iii) based on the comparisons performed across the three validation input-label pairs, deriving a respective instance-specific measure of the performance of the given instance of the time-series model.

As noted above, the back-end computing platform 102 may perform this functionality across the sub-batches of model instances that have been generated for each respective hyperparameter combination.

In turn, for each respective hyperparameter combination, the back-end computing platform 102 may determine a respective measure of performance for the respective hyperparameter combination based on the respective instance-specific measures of performance that have been derived for the instances of the time-series model having the respective hyperparameter combination. For example, for a given hyperparameter combination, the back-end computing platform 102 may function to determine a given measure of performance for the given hyperparameter combination by aggregating the respective instance-specific measures of performance (e.g., MAPE values) that have been derived for the instances of the time-series model having the given hyperparameter combination (e.g., by taking an average, a summation, or the like), among other possibilities.

As result of this functionality, the back-end computing platform 102 may produce a respective measure of performance for each respective hyperparameter combination. In turn, the back-end computing platform 102 may identify the particular hypermeter combination that delivers the best measure of performance (e.g., the hypermeter combination having the lowest aggregated MAPE value) and then select a candidate time-series model having the identified hyperparameter combination as the optimal time-series model for the given model type.

The back-end computing platform 102 may carry out similar functionality for each of the other model types for which time-series models are generated, thereby resulting in identification of an optimal time-series model for each such model type.

While the foregoing describes one possible implementation of functionality for performing hyperparameter tuning in order to identify an optimal time-series model for each model type, it should be understood that the back-end computing platform 102 could be configured to apply any hyperparameter tuning technique now known or later developed in order to an optimal time-series model for each model type-including but not limited to the possibility that the back-end computing platform 102 may generate and test a single instance of a time-series model for each respective hyperparameter combination (rather than multiple instances). Further, in line with the discussion above, it should also be understood that the back-end computing platform 102 could also be configured to identify more than one optimal time-series model for each model type.

At block 510, the back-end computing platform 102 may then define the given set of time-series models to include the respective optimal time-series model for each model type. For example, the back-end computing platform 102 may define the given set of time-series models to include a first optimal time-series model for a SARAMAX model type, a second optimal time-series model for an Unobserved Components model type, and so on for any other model type for which a batch of candidate time-series models was generated. Additionally, the back-end computing platform 102 may store an indication of the given set of time-series models in the data storage layer of the back-end computing platform 102 so that it can be referenced in the future by the server-side software 103.

In line with the discussion above, the time-series model generation sub-component 401 may repeat the foregoing functionality for each respective set of time-series models that is to be generated by the time-series model generation sub-component 401. For instance, referring back to the example implementation of FIG. 4, the time-series model generation sub-component 401 may carry out two iterations of the foregoing functionality—a first iteration for generating the first set of time-series models that are configured to forecast values of the target time-series variable for a shorter-term target timeframe and a second iteration for generating the second set of time-series models that are configured to forecast values of the target time-series variable for a longer-term target timeframe.

The functionality that is carried out by the back-end computing platform 102 installed with the model building component 105 (and more particularly, the time-series model generation sub-component 401) in order to generate a given set of time-series models may take various other forms as well.

Further, the back-end computing platform 102 may carry out the functionality of FIG. 5 in response to any of various triggering events. For instance, as one possibility, a user may input a request to initiate the functionality of FIG. 5 into a GUI of the disclosed time-series forecasting tool, such as one of the example GUIs described herein, and the back-end computing platform 102 may then initiate the functionality of FIG. 5 in response to receiving an indication of that request from a user's client device 110 over the respective communication path between the client device 110 and the back-end computing platform 102. The back-end computing platform 102 may carry out the functionality of FIG. 5 in response to other triggering events as well.

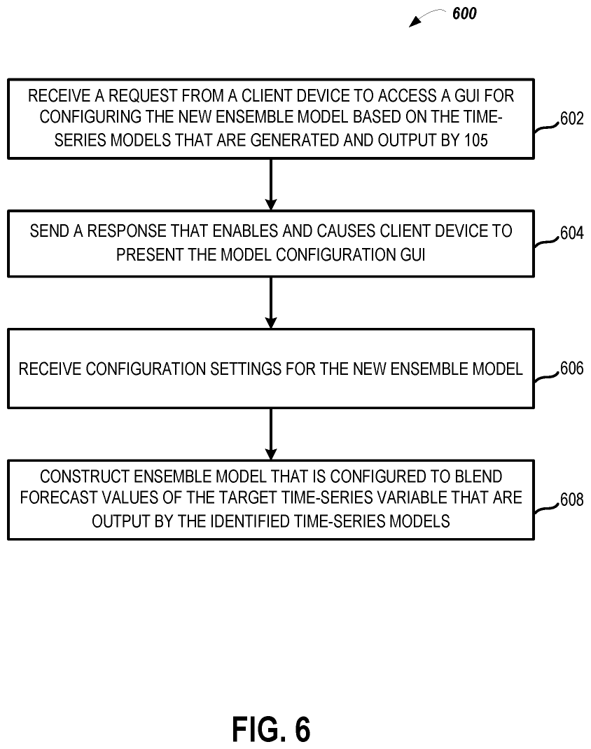

Referring back to FIG. 4, at a high level, the ensemble model configuration sub-component 402 may provide functionality for building an ensemble model based on a selected subset of the time-series models that are generated and output by the time-series model generation sub-component 401. This functionality may take any of various forms, and one possible implementation of such functionality is illustrated in FIG. 6. For purposes of illustration, the example functionality 600 of FIG. 6 is described as being carried out by the back-end computing platform 102 of FIG. 1 that is installed with the model building component 105, but it should be understood that the example functionality of FIG. 6 may be carried out by any computing platform that is capable of running the software disclosed herein. Further, it should be understood that the example functionality of FIG. 6 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular embodiment.

As shown in FIG. 6, the example functionality 600 may begin at block 602 with the back-end computing platform 102 receiving a request from a client device 110 to access a GUI for configuring the new ensemble model based on the time-series models that are generated and output by the time-series model generation sub-component 401, which may be referred to herein as the “model configuration GUI” of the time-series forecasting tool. In practice, this request may take the form of one or more request messages (e.g., one or more HTTP messages) that are sent over the respective communication path between the client device 110 and the back-end computing platform 102 (which as noted above may include at least one data network), and in at least some implementations, the one or more request messages may be sent via an API. The request to access the model configuration GUI may take other forms and/or be received in other manners as well.

At block 604, after receiving the request to access the model configuration GUI, the back- end computing platform 102 may send a response to the client device 110 that enables and causes the client device 110 to present the model configuration GUI. In practice, this response may take the form of one or more messages (e.g., one or more HTTP messages) that are sent over the respective communication path between the back-end computing platform 102 and the client device 110 (which as noted above may include at least one data network), and in at least some implementations, the one or more response messages may be sent via an API. Further, the response that is sent to the client device 110 may comprise instructions and data for presenting the model configuration GUI, which the client device 110 may utilize to present the GUI of the time-series forecasting tool to the user.

In accordance with the present disclosure, the model configuration GUI of the time-series forecasting tool that is presented by the client device 110 may include various GUI input elements (e.g., buttons, text input fields, dropdown lists, slider bars, etc.) that enable the user to input configuration parameters for the new ensemble model. For instance, in line with the discussion above, the model configuration GUI of the time-series forecasting tool that is presented by the client device 110 may include GUI input elements that enable the user to specify which of the generated time-series models to include in the ensemble model and also input corresponding weights for at least some of the identified time-series models, among other possibilities.

In some implementations, the model configuration GUI could also be used to initiate the process of generating the sets of time-series models that form the basis for the ensemble model. For instance, the model configuration GUI of the time-series forecasting tool could include a selectable button or the like that enables a user to request that the model building component 105 (and more particularly, the time-series model generation sub-component 401) initiate the aforementioned process for generating the sets of time-series models. In these implementations, the functionality of blocks 602-604 may be carried out before the sets of time-series models are generated by the model building component 105, and then after that process is completed, the model configuration GUI may then allow the user to proceed with the task of configuring the ensemble model in the manner described herein.

The user may then interact with the model configuration GUI of the time-series forecasting tool to input configuration parameters for the new ensemble model. For example, the user may use the model configuration GUI to specify which time-series models to include in the ensemble model by selecting the time-series models from the generated sets of time-series models that are presented via the model configuration GUI, among other possible ways that the time-series models may be specified via the model configuration GUI. In this respect, the model configuration GUI may present the different sets of time-series models in the form of separate lists (e.g., a first list for the shorter-term models and a second list for the longer-term models), or as a single, combined list where the target timeframe for each of the listed models is indicated in some way, among other possible ways that the generated sets of time-series models may be presented. As another example, the user may use the model configuration GUI to specify corresponding weights for at least some of the selected time-series models by typing the weights into the model configuration GUI or selecting the weights from a list of available options that are presented via the model configuration GUI, among other possible ways that the weights for the time-series models may be input via the model configuration GUI.

To illustrate with a one representative example, the user could use the model configuration GUI to specify (i) a first time-series model from the first set of time-series models that are configured forecast values of the time-series variable for the shorter-term timeframe, and (ii) a second time-series model from the second set of time-series models that are configured forecast values of the time-series variable for the longer-term timeframe. In this example, each of the identified time-series models may be assigned a default weight of 1 because the forecast values of the first time-series model are not being blended with any other forecast values for the shorter-term target timeframe and the forecast values of the second time-series model are not being blended with any other forecast values for the longer-term target timeframe.

To illustrate with another representative example, the user could use the model configuration GUI to specify (i) multiple time-series models from the first set of time-series models that are configured forecast values of the time-series variable for the shorter-term timeframe along with corresponding weights for blending the forecast values of the multiple time-series models within the shorter-term target timeframe, where those weights preferably add up to a total of 1 (e.g., weights of 0.5 and 0.5 for two models), and (ii) one time-series models from the second set of time-series models that are configured forecast values of the time-series variable for the longer-term timeframe, which may be assigned a default weight of 1 because its forecast values are not being blended with any other forecast values for the longer-term target timeframe.

To illustrate with yet another representative example, the user could use the model configuration GUI to specify (i) one time-series model from the first set of time-series models that are configured to forecast values of the time-series variable for the shorter-term timeframe, which may be assigned a default weight of 1 because its forecast values are not being blended with any other forecast values for the shorter-term target timeframe, and (ii) multiple time-series models from the second set of time-series models that are configured forecast values of the time-series variable for the longer-term timeframe along with corresponding weights for blending the forecast values of the multiple time-series models within the longer-term target timeframe, where those weights preferably add up to a total of 1 (e.g., weights of 0.5 and 0.5 for two models).

To illustrate with still another representative example, the user could use the model configuration GUI to specify (i) multiple time-series models from the first set of time-series models that are configured forecast values of the time-series variable for the shorter-term timeframe along with corresponding weights for blending the forecast values of the multiple time-series models within the shorter-term target timeframe, where those weights preferably add up to a total of 1 (e.g., weights of 0.5 and 0.5 for two models), and (ii) multiple time-series models from the second set of time-series models that are configured forecast values of the time-series variable for the longer-term timeframe along with corresponding weights for blending the forecast values of the multiple time-series models within the longer-term target timeframe, where those weights preferably add up to a total of 1 (e.g., weights of 0.5 and 0.5 for two models).

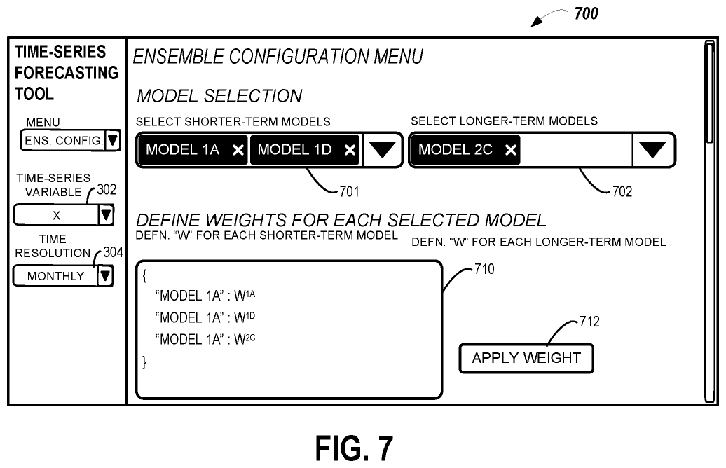

Turning now to FIG. 7, an example GUI view 700 for the model configuration GUI may include a set of input elements (e.g., fillable text fields, dropdown lists, etc.) that enable the user to input specifications for configuring an ensemble model. For instance, the GUI view 700 comprises input elements that enable a user to input (i) a selection of one or more time-series models from a first set of time-series models that are configured to forecast values of the time-series variable for the shorter-term timeframe, (ii) a selection of one or more time-series models from a second set of time-series models that are configured to forecast values of the time-series variable for the longer-term timeframe, and (iii) corresponding weights for blending the forecast values output by each of the multiple time-series models within the target model window.

To that end, in an example, the GUI view 700 includes a shorter-term timeframe model selection input field 701 and a longer-term timeframe selection input field 702, each of which may be an input field (e.g., a dropdown list, a text input field, etc.) configured to receive input for a specification of one or more candidate models, of the respective sets of models, for selection for inclusion in an ensemble model. Further, in some examples, the GUI view 700 includes a model weight input field 710, wherein a user may provide a specification of one or more weights “W,” with which to weigh the output of an individual model, within the ensemble model, for compiling the resultant ensemble model. Further still, in some examples, the GUI view 700 may include a selector input field 712, which may be a simple input, such as a button, that is selected to indicate that the input to the other fields (e.g., fields 701, 702, 710) is complete and a user presented with the GUI view 700 wishes to submit data, based on a specification of the inputs to fields 701, 702, 710, to the back-end computing platform 102, for generating an ensemble model.

Returning to FIG. 6, based on the user input, the client device 110 may send the configuration parameters for the new ensemble model to the back-end computing platform 102, and at block 606, the back-end computing platform 102 may receive configuration parameters for the new ensemble model. In practice, the configuration parameters may be contained within one or more request messages (e.g., one or more HTTP messages) that are sent over the respective communication path between the client device 110 and the back-end computing platform 102 (which as noted above may include at least one data network), and in at least some implementations, the one or more request messages may be sent via an API. The configuration parameters may take other forms and/or be received in other manners as well.

At block 608, based on the received configuration parameters, the back-end computing platform 102 may construct an ensemble model that is configured to blend forecast values of the target time-series variable that are output by the identified time-series models. In this respect, at a minimum, the ensemble model that is constructed by the back-end computing platform 102 may be configured to blend forecast values of the time-series variable across different target timeframes, such as by blending forecast values for a shorter-term target timeframe with forecast values for a longer-term target timeframe. Additionally, the ensemble model that is constructed by the back-end computing platform 102 could also be configured to blend forecast values for the same target timeframe, such as by determining a weighted average of the forecast values that are output by multiple time-series models for the same target timeframe in accordance with respective weights that have been assigned to the multiple time-series models. The ensemble model that is constructed by the back-end computing platform 102 may take other forms as well.

The functionality that is carried out by the back-end computing platform 102 installed with the model building component 105 (and more particularly, the ensemble model configuration sub-component 402) in order to configure an ensemble model may take various other forms as well. For instance, while the aforementioned functionality relates to an embodiment where a user selects the time-series models and corresponding weights for the new ensemble model, in other embodiments, it is possible that the back-end computing platform 102 installed with the model building component 105 could automatically select the time-series models and/or corresponding weights for the new ensemble model, or at least could make an initial selection of the time-series models and/or corresponding weights for the new ensemble model that is then presented to the user as a recommendation which can either be adopted, modified, or rejected by the user. In this respect, the back-end computing platform 102 could automatically select the time-series models and corresponding weights for the new ensemble model based on any of various factors, including but not limited to the performance measures that are determined during the hyperparameter tuning process. For example, for each of the first and second sets of time-series models, the back-end computing platform 102 could use the performance measures of the time-series models as a basis for selecting a given subset of the time-series models in the set (e.g., based on a performance-measure threshold, a ranking based on performance measure, or a combination thereof), and if the selected subset includes multiple time-series models, the back-end computing platform 102 could then either assign each such time-series model an equal weight (e.g., a weight having a value that is equal to 1 divided by the number of models) or could determine the respective weights of the time-series models based on the respective performance measures of the time-series models (e.g., models with higher performance measures are assigned higher weights and models with lower performance measures are assigned lower weights), among other possibilities. Other examples are possible as well.

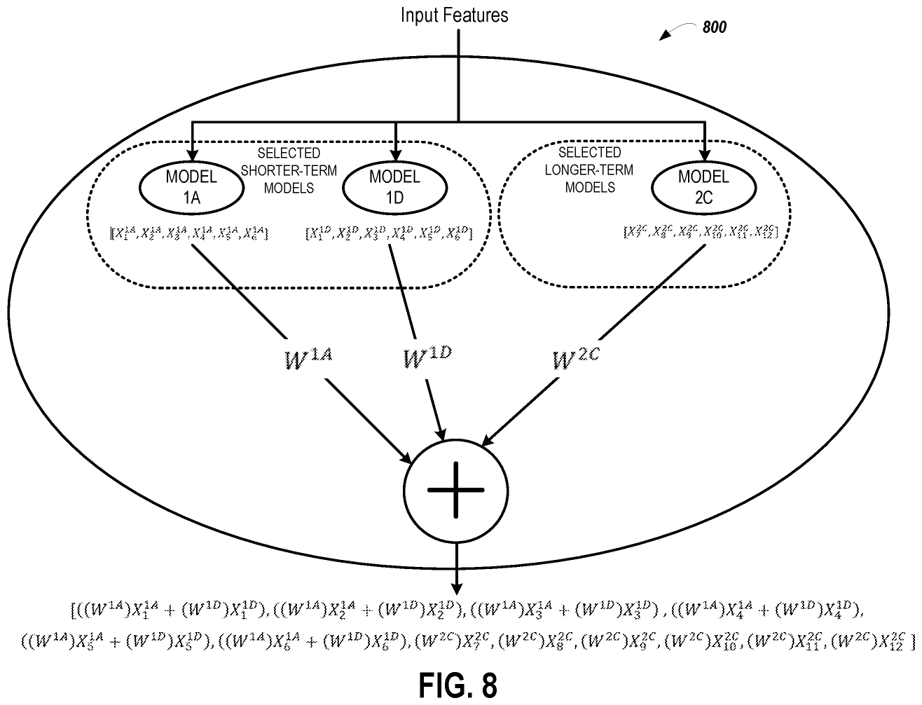

Turning next to FIG. 8, a conceptual illustration of one possible example of an ensemble model 800 that may be constructed in accordance with the disclosed software technology is shown.

As illustrated in FIG. 8, the example ensemble model 800 may be constructed to have one or more input features for which input data is to be obtained and provided as input to the underlying time-series models of the example ensemble model 800. This set of one or more input features may take any of various forms. For instance, in line with the discussion above, the set of one or more input features may include at least a first input feature comprising a sequence of past values for the target time-series variable that are from the look-back window for the new ensemble model, and to the extent that one or more influencing variables have been defined for the new ensemble model, may also include an additional input feature corresponding to each such influencing variable that comprises (i) a sequence of past values for the influencing variable that are from the look-back window for the new ensemble model and (ii) a sequence of future values for the influencing variable that are from the forecast window for the new ensemble model. Other input features are possible as well.

As further illustrated in FIG. 8, the example ensemble model 800 may be constructed to include at least one of the first set of time-series models that are configured to forecast values of the target time-series variable for a shorter-term target window and at least one of the second set of time-series model that are configured to forecast values of the target time-series variable for a longer-term target window. More particularly, the example ensemble model 800 is illustrated to include (i) MODEL 1A and MODEL 1D, which are two shorter-term models selected from the first set of time-series models that are configured to forecast values of the target time-series variable for a shorter-term target window, and (ii) MODEL 2C, which is one longer-term model selected from the second set of time-series models that are configured to forecast values of the target time-series variable for a longer-term target window. In this example, the two shorter-term models are each configured to have an output feature comprising a sequence of 6 future values for the given time-series variable that constitute monthly values for the first 6 months after the shorter-term model is executed.

This output feature is illustrated in FIG. 8 underneath each of the shorter-term models. In particular, the output feature of Model 1A is represented as:

[X₁^{1A}, X₂^{1A}, X₃^{1A}, X₄^{1A}, X₅^{1A}, X₆^{1A}], and the output feature of Model 1D is represented as: [X₁^{1D}, X₂^{1D}, X₃^{1D}, X₄^{1D}, X₅^{1D}, X₆^{1D}], where “X” represents a forecast value for a respective forecast time, the subscript identifies the month for which the forecast value is being predicted (e.g., 1 identifies the first month after the execution date of the model for which a forecast value is predicted, 2 identifies the second month after the execution date of the model for which a forecast value is predicted, etc.), and the superscript identifies the model that output the forecast value.

Additionally, the one longer-term model is configured to have an output feature comprising a sequence of 6 future values for the given-time series variable that constitute monthly values for the longer-term timeframe that begins when the shorter-term timeframe ends and spans the next 6 months thereafter (i.e., the seventh through twelfth month after the execution date of the model). This output feature is illustrated in FIG. 8 underneath the longer-term model. In particular, the output feature of Model 2B is represented as [X₇^{2C}, X₈^{2C}, X₉^{2C}, X₁₀^{2C}, X₁₁^{2C}, X₁₂^{2C}], where “X” represents a forecast value for a respective forecast time, the subscript identifies the month for which the forecast value is being predicted (e.g., 7 identifies the seventh month after the execution date of the model for which a forecast value is predicted, 8 identifies the eighth month after the execution date of the model for which a forecast value is predicted, etc.), and the superscript identifies the model that output the forecast value.

In line with the discussion above, each of Model 1A, Model 1D, and Model 2C has also been assigned a respective weight “W” that is to be utilized by the ensemble model 800 when blending the respective outputs of Model 1A, Model 1D, and Model 2C in order to produce the ensemble model's output. As illustrated, each model's respective weight is represented by a “W” with a superscript identifying the model to which the weight has been assigned. Further, in line with the discussion above, the weights W^{1A} and W^{1D} assigned to shorter-term Models 1A and 1D will preferably add up to 1, and the weight W^{2C} assigned to longer-term Model 2B will preferably be a default value of 1 given that it will not be blended with any other longer-term models, but other weight values are possible as well.

The example ensemble model 800 is then configured to blend the outputs of the respective outputs of Model 1A, Model 1D, and Model 2C in accordance with their assigned weights. In this respect, the example ensemble model 800 may be configured the blend the forecast values output by shorter-term Models 1A and 1D for the shorter-term target timeframe by determining a weighted average of their forecast values for each month in accordance with their respective weights, and may blend those values for the shorter-term target timeframe with the forecast values output by longer-term Model 2C for the longer-term timeframe, thereby producing the output feature of the example ensemble model 800. This output feature is illustrated in FIG. 8 underneath the example ensemble model 800, and uses the same notation described previously to represent the respective forecast values and weights of Models 1A, 1D, and 2C.

In the illustrated example of FIG. 8, the output feature of the ensemble model 800 may be a blended output based on a combination of the selected shorter-term models and the selected longer-term models. In an example and as illustrated, the output feature may comprise a blended output, via utilizing a weighted summation of multiple model outputs within each set of selected models, wherein the weighted summation is governed by the input assigned weights “W.” In such examples, a summation of the respective weights (e.g., W^{IA}+W^{1D}) is about 1, such that a forecasted value based on a summation of the weighted output will not be inflated or deflated based on excess weighting. In some additional or alternative examples, the output feature may combine outputs across the timeframes for the respected shorter-term and longer-term models, such that the output feature comprises a set of values for the time-series value “X” that combines weighted output of the selected shorter-term and longer-term models at their respective forecast windows.

It should be understood that the example ensemble model 800 of FIG. 8 is merely one possible example that is shown for purposes of illustration, and that the disclosed software technology may be utilized to construct ensemble models that take various other forms as well.

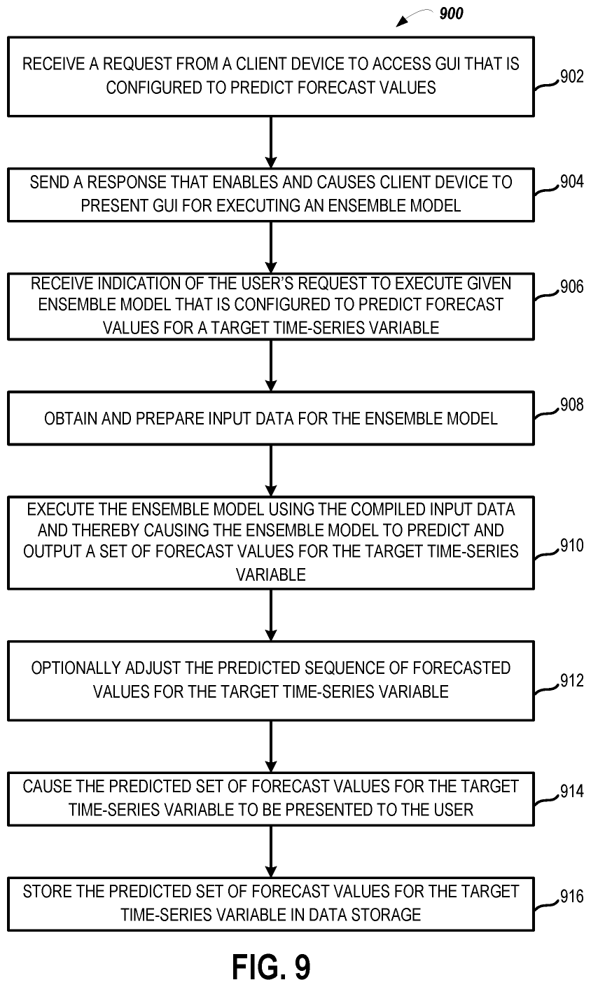

Referring again to FIG. 1, at a high level, the model execution component 106 of the server-side software 103 may cause the back-end computing platform 102 to carry out functionality for executing an ensemble model that was built using the example model building component 105. This functionality may take any of various forms, and one possible implementation of such functionality is illustrated in FIG. 9. For purposes of illustration, the example functionality 900 of FIG. 9 is described as being carried out by the back-end computing platform 102 of FIG. 1 that is installed with the model execution component 106, but it should be understood that the example functionality 900 of FIG. 9 may be carried out by any computing platform that is capable of running the software disclosed herein. Further, it should be understood that the example functionality 900 of FIG. 9 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular embodiment.

As shown in FIG. 9, the example functionality 900 may begin at block 902 with the back-end computing platform 102 receiving a request from a client device 110 to access a GUI that is configured to predict forecast values for a target time-series variable, which may be referred to herein as the “model execution GUI” of the time-series forecasting tool. In practice, this request may take the form of one or more request messages (e.g., one or more HTTP messages) that are sent over the respective communication path between the client device 110 and the back-end computing platform 102 (which as noted above may include at least one data network), and in at least some implementations, the one or more request messages may be sent via an API. The request to access the model execution GUI may take other forms and/or be received in other manners as well.

At block 904, after receiving the request to access the model execution GUI, the back-end computing platform 102 may send a response to the client device 110 that enables and causes the client device 110 to present the model execution GUI. In practice, this response may take the form of one or more messages (e.g., one or more HTTP messages) that are sent over the respective communication path between the back-end computing platform 102 and the client device 110 (which as noted above may include at least one data network), and in at least some implementations, the one or more response messages may be sent via an API. Further, the response that is sent to the client device 110 may comprise instructions and data for presenting the model execution GUI, which the client device 110 may utilize to present the GUI of the time-series forecasting tool to the user.

In accordance with the present disclosure, the model execution GUI of the time-series forecasting tool that is presented by the client device 110 may include GUI input elements (e.g., buttons, text input fields, dropdown lists, slider bars, etc.) that enable the user to input a request to execute an ensemble model, as well as GUI output elements that enable the user to view the forecast values for the target time-series variable that are predicted by the ensemble model that is executed.

The user may interact with the model execution GUI of the time-series forecasting tool to input a request to execute a particular ensemble model that has previously been built in the manner described above. For example, the user may use the model execution GUI to specify which ensemble model to execute by selecting the ensemble model from a list of options that are presented via the model configuration GUI (if there are multiple ensemble models available) and/or clicking a selectable button for executing the ensemble model, among other possible ways that the user input a request to execute a particular ensemble model via the model execution GUI.

Returning to FIG. 9, based on the user input, the client device 110 may send an indication of the user's request to the back-end computing platform 102, and at block 906, the back-end computing platform 102 may receive the indication of the user's request to execute a given ensemble model that is configured to predict forecast values for a target time-series variable. In practice, the indication of the user's request may be contained within one or more request messages (e.g., one or more HTTP messages) that are sent over the respective communication path between the client device 110 and the back-end computing platform 102 (which as noted above may include at least one data network), and in at least some implementations, the one or more request messages may be sent via an API. The indication of the user's request to execute the given ensemble model may take other forms and/or be received in other manners as well.

At block 908, the back-end computing platform 102 may obtain and prepare input data for the ensemble model. Such input data may take any of various forms.

For instance, in line with the discussion above, one type of input data that may be obtained and prepared by the back-end computing platform 102 may take the form of data for an input feature comprising a sequence of past values for the target time-series variable that are from the look-back window for the given ensemble model. Additionally, another type of input data that may optionally be obtained and prepared by the back-end computing platform 102 may take the form of data for an input feature that corresponds to an influencing variable defined for the given ensemble model and comprises (i) a sequence of past values for the influencing variable that are from the look-back window for the given ensemble model and (ii) a sequence of future values for the influencing variable that are from the forecast window for the new ensemble model. The input data that is obtained and prepared by the back-end computing platform 102 may take other forms as well.

Further, the back-end computing platform 102 may obtain the input data for execution of the given ensemble model in any of various manners. For instance, as one possibility, the user may enter at least some of the input data for the given ensemble model into the model execution GUI in conjunction with requesting execution of the given ensemble model, in which case the back-end computing platform 102 may receive such input data from the user's client device 110 along with the indication of the user's request to execute the given ensemble model. In this respect, the model execution GUI may enable a user to enter at least some types of input data for use in executing the given ensemble model by typing such input data into the model execution GUI, selecting such input data from a list of available options that are presented via the model execution GUI, or uploading a data file that contains such input data, among other possible ways that a user may enter input data into the model execution GUI.

As another possibility, the back-end computing platform 102 may already have at least some of the input data for the given ensemble model stored in its data storage layer (e.g., as a result of ingesting such data from a data source, previously receiving such data from a user via a GUI of the disclosed time-series forecasting tool, etc.), in which case the back-end computing platform 102 may obtain such input data by accessing and loading it from the data storage layer of the back-end computing platform 102 (or perhaps some other data store). For instance, the back-end computing platform 102 may be configured to determine the time range for which to access and load the past values of the target time-series variable based on the model setup parameters (e.g., the specification of the look-back window), user input received via the model execution GUI (e.g., user input specifying the starting point or ending point for the look-back window), or some combination thereof, and may then access and load the previously-stored values of the target time-series variable that fall within the determined time range. Likewise, the back-end computing platform 102 may be configured to determine the time range for which to access and load the past and figure values of an influencing variable based on the model setup parameters (e.g., the specification of the look-back and forecast windows), user input received via the model execution GUI (e.g., user input specifying the starting point or ending point for the look-back window), or some combination thereof, and may then access and load the previously-stored values of the influencing variable that fall within the determined time range. The functionality of accessing and loading input data from the data storage layer of the back-end computing platform 102 may take other forms as well.

As yet another possibility, the back-end computing platform 102 may obtain at least some of the input data for the given ensemble model by requesting and receiving it from a third-party data source.

The back-end computing platform 102 may obtain the input data for use in executing the given ensemble model in other manners as well.

Along with obtaining the input data as described above, the back-end computing platform 102 may also obtain data for one or more offset variables that are to be backed out of or added into the target time-series variable in order to normalize (or “clean”) the values for the target time-series variable. For instance, in a scenario where historical data for one or more offset variables was used to normalize the historical data for the target time-series variable before that historical data was used to build the given ensemble model, then along similar lines, data for one or more offset variables should be used to normalize the input data for the target time-series variable before that input data is used to execute the given ensemble model. In operation, the back-end computing platform 102 may obtain the data for one or more offset variables in a similar manner to how the back-end computing platform 102 obtains the input data (e.g., via the model execution GUI, accessing and loading from a data storage layer, or receiving from a third-party data source).

Further yet, the back-end computing platform 102 may optionally perform certain data preparation operations on the input data (if necessary) in order to place it into a form that can be used as execute the given ensemble model. These data preparation operations could take any of various forms.

For instance, to the extent that the obtained input data includes values having different time resolutions than the defined time resolution for the given ensemble model, one type of data preparation operation performed by the back-end computing platform 102 may involve resampling certain of the input data in order to align the time resolutions of the input values. For example, if the values for the target time-series variable and/or a given influencing variable have a different time resolution than the defined time resolution for the given ensemble model, then the back-end computing platform 102 may down-sample (e.g., via aggregation) or up-sample (e.g., via interpolation) the input values for the target time-series variable and/or a given influencing variable in order to align the time resolution of that input data with the defined time resolution of the given ensemble model. Other examples are possible as well.

Further, another type of data preparation operation performed by the back-end computing platform 102 may involve normalizing the input data for the target time-series variable based on the obtained data for one or more offset variables so as to produce updated input data (i.e., “normalized” or “baseline” input data) for the target time-series variable, which may involve increasing or decreasing the input values of the given time-series data variable. In this respect, if the obtained values for a given offset variable have a different time resolution than the defined time resolution for the given ensemble model, then along similar lines to the above, the back-end computing platform 102 may down-sample (e.g., via aggregation) or up-sample (e.g., via interpolation) the obtained values for the given offset variable in order to align the time resolution of that obtained data with the defined time resolution of the given ensemble model. Further yet, another type of data preparation operation performed by the back-end computing platform 102 may involve removing outliers.

The data preparation operations that may optionally be performed by the back-end computing platform 102 may take various other forms as well.

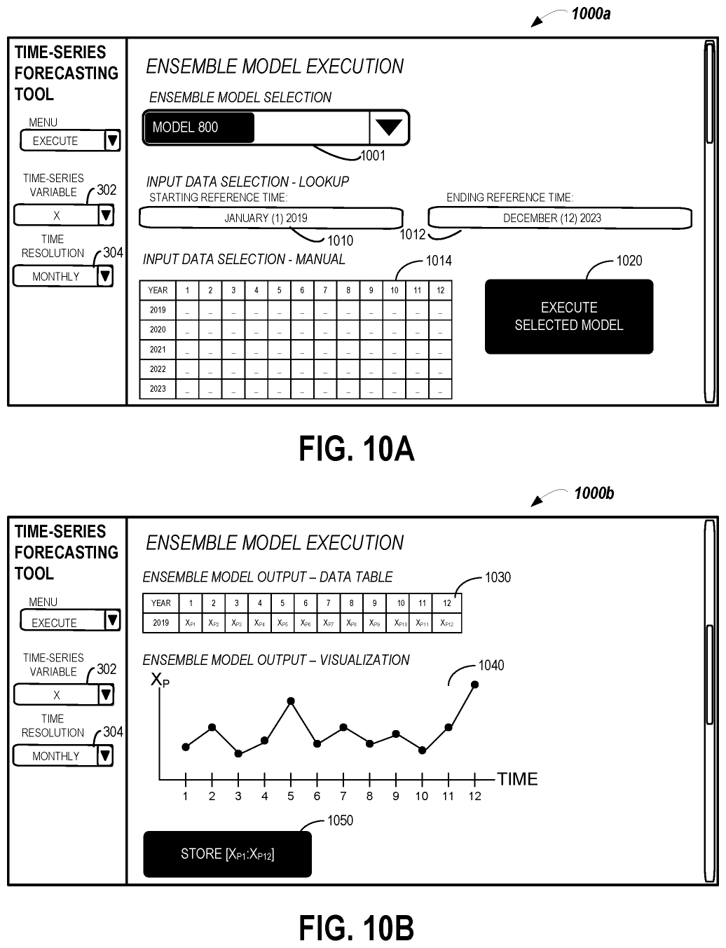

Turning now to FIG. 10A, an example first GUI view 1000a that enables a user to initiate execution of an ensemble model, via the model execution component 106, in accordance with the present disclosure is illustrated. For instance, the first GUI view 1000a for a model execution GUI comprises input elements that enable a user to (i) input a model selection for an ensemble model, (ii) input a selection range for stored data for input to the selected ensemble, (iii) input data for input to the selected ensemble model, and (iv) with the input fields satisfied, input to provide the back-end computing platform 102 with instructions to execute the selected ensemble model with the input or retrieved data as input.

To that end, as shown, the first GUI view 1000a may include a set of input elements (e.g., fillable text fields, dropdown lists, etc.) that enable the user to provide the aforementioned input. For example, the first GUI view 1000a may include a ensemble model selection input field 1001, wherein a given ensemble model may be selected for execution. Further, the beginning and ending date input data input fields 1010, 1012, wherein the beginning date input data input field 1010 receives an indication from a user of a client device 110 for a starting time, in a time-series, from which to retrieve input data values for input as the input data for the ensemble model. The ending date input data input field 1012 receives input for an ending time, in a time-series, from which to retrieve input data for input as the input data to the ensemble model. Additionally or alternatively, the GUI view may include a manual input data input field 1014, wherein a user of the client device 110 may manually provide input data to the first GUI view 1000a, for use by the ensemble model as input data. Finally, in some examples, the first GUI view 1000a may include an execution start input element 1020, which may be a simple selector which receives an input to indicate that a user wishes to execute the selected ensemble model, based on input to the other fields 1001, 1010, 1012, 1014 of the first GUI view 1000a.

Returning to FIG. 9, at block 910, after obtaining and preparing the input data for use in executing the given ensemble model, the back-end computing platform 102 may execute the given ensemble model using the input data and thereby cause the given ensemble model to predict and output a sequence of forecast values for the target time-series variable. For instance, the back-end computing platform 102 may provide the input data as input to the given ensemble model, which may then function to (i) provide the input data to each of its underlying time-series models and thereby causing each of the underlying time-series models to output a respective prediction comprising a forecasted sequence of values of the target time-series variable for a target timeframe (e.g., a shorter-term or longer-term target timeframe), which is sometimes referred to as “fitting” the time-series models to the input data, (ii) blend the respective predictions of the underlying time-series models together in accordance with the model configuration parameters of the given ensemble model. In this respect, at a minimum, the given ensemble model may be configured to blend forecast values of the time-series variable across different target timeframes, such as by blending forecast values for a shorter-term target timeframe with forecast values for a longer-term target timeframe. Additionally, the given ensemble model could also be configured to blend forecast values for the same target timeframe, such as by determining a weighted average of the forecast values that are output by multiple time-series models for the same target timeframe in accordance with respective weights that have been assigned to the multiple time-series models. The functionality of the given ensemble model may take other forms as well.

At block 912, after causing the given ensemble model to predict and output the sequence of forecast values for the target time-series variable, the back-end computing platform 102 may optionally adjust the predicted sequence of forecast values for the target time-series variable. For instance, as one possibility, the back-end computing platform 102 may optionally adjust the predicted sequence of forecast values for the target time-series variable based on projected values for one or more offset variables that were previously backed out of or added into the target time-series variable, where such data may be obtained in a similar manner to the functionality described above. As another possibility, the back-end computing platform 102 may optionally adjust the predicted sequence of forecast values for the target time-series variable based on user input specifying an adjustment factor for one or more of the forecast values (e.g., a multiplication factor of more or less than 1). For example, if the user is aware of a future event that is expected to take place in a particular month and have an impact on the value of the target time-series variable in that month, the user may input an adjustment factor for that month via the model execution GUI (and/or some other GUI of the disclosed time-series forecasting tool), and the back-end computing platform 102 may then increase the forecast value of the target time-series variable for that month in accordance with the adjustment factor. The function of adjusting the predicted sequence of forecast values for the target time-series variable may take other forms as well.

At block 914, the back-end computing platform 102 may cause the predicted sequence of forecast values for the target time-series variable to be presented to the user. For example, the back-end computing platform 102 may cause a client device 110 associated with the user to show the predicted sequence of forecast values for the target time-series variable within the model execution GUI (or some other GUI that is displayed to the user). In practice, this function may involve sending the predicted sequence of forecast values within one or more messages (e.g., one or more HTTP messages) to the client device 110 over the respective communication path between the back-end computing platform 102 and the client device 110 (which as noted above may include at least one data network), and in at least some implementations, the one or more response messages may be sent via an API. Further, the response that is sent to the client device 110 may comprise instructions and data for presenting the predicted sequence of forecast values to the user, which the client device 110 may utilize to present the predicted sequence of forecast values to the user.

The model execution GUI could present the predicted sequence of forecast values for the target time-series variable to the user in various ways. For example, the predicted sequence of forecast values could be shown in the form of a list or a two-dimensional graph, among other possibilities. Further, in line with the discussion above, the predicted sequence of forecast values for the target time-series variable could be presented either in original form or in an adjusted form, if the predicted sequence of forecast values are adjusted based on projected offset data. The manner in which the predicted sequence of forecast values for the target time-series variable are presented to the user could take other forms as well.

Turning now to FIG. 10B, an example second example GUI of the model execution GUI that enables a user to view the output of an ensemble model, in accordance with the present disclosure is illustrated. For instance, the second GUI view 1000b comprises visual indicators of a predicted sequence of forecast values for a target time-series variable of an executed ensemble model.

As shown, the second GUI view 1000b may include one or more data representations that provide a user who is viewing the second GUI view 1000b with one or more indications of the predicted sequence of forecast values for a target time-series variable ([X_{P1}: X_{P12}]), as forecasted by the executed ensemble model. In an example, the second GUI view 1000b includes a text or numerical based data table 1030, including raw data representations of the predicted sequence of forecast values for a target time-series variable, organized by the reference times at which the forecasted values are forecasted. In another example, the second GUI view 1000b may include a visualization-based indication 1040 of the predicted sequence of forecast values for a target time-series variable, such as a plot, a graph, a chart, etc. Other known data-representations for the predicted sequence of forecast values for a target time-series variable are contemplated and may be presented via the second GUI view 1000b, as well.

Further still, as illustrated in the example second GUI view 1000b of FIG. 10B, an output storage instruction input element 1050 may be configured to receive an indication of the user's wish to store the predicted sequence of forecast values X_{P1}: XP₁₂. In response to than indication determined via input to the output storage instruction input element 1050, a client device 110 displaying the second GUI view 1000b may send an indication of the user's request to the back-end computing platform 102 and the back-end computing platform 102 may receive the indication of the user's request to store the predicted sequence of forecast values X_{P1}: XP₁₂. In practice, the indication of the user's request may be contained within one or more request messages (e.g., one or more HTTP messages) that are sent over the respective communication path between the client device 110 and the back-end computing platform 102 (which as noted above may include at least one data network), and in at least some implementations, the one or more request messages may be sent via an API. The indication of the user's request to store the predicted sequence of forecast values X_{P1}:X_{P12} may take other forms and/or be received in other manners as well

To that end, whether initiated via user input to a client device 110 or performed automatically, at block 916, the back-end computing platform 102 may additionally store the predicted sequence of forecast values for the target time-series variable in its data storage layer so that this forecast data can be accessed later.

The back-end computing platform 102 may also take other actions based on the predicted sequence of forecast values for the target time-series variable. For example, the back-end computing platform 102 may utilize the forecasted values for the time-series variable, generated by the model execution component 106, as input values into some other downstream data science model. As another example, the back-end computing platform 102 may generate notifications and/or alerts based on the forecasted values for the time-series variable, generated by the model execution component 106, which, for example, may be presented to a user via a client device 110. Other examples of actions taken by the back-end computing platform 102 based on the predicted sequence of forecast values for the target time-series variable are possible as well.

The functionality that is carried out by the model execution component 106 in order to execute an ensemble model may take various other forms as well.

Referring again to FIG. 1, at a high level, the model evaluation component 107 of the server-side software 103 may cause the back-end computing platform 102 to carry out functionality that enables users to engage in any of various tasks for evaluating and/or adjusting an ensemble model that is built using the disclosed time-series forecasting tool These tasks may take any of various forms.

For instance, as one possibility, the model evaluation component 107 of the server-side software 103 may cause the back-end computing platform 102 to carry out functionality that enables a user to inspect a version-over-version (“VoV”) comparison of a predicted sequence of forecast values for a target time-series variable. In an example, a VoV comparison of a predicted sequence of forecast values for a target time-series variable may comprise a comparison of a current predicted sequence of forecast values for a target time-series variable versus a past predicted sequence of forecast values for a target time-series variable. The past predicted sequence of forecast values for a target time-series variable may be a result of a prior execution of a prior version of the ensemble model, from which the current predicted sequence of forecast values for a target time-series variable were output. A VoV comparison may be then used by the user to determine if the ensemble model has improved, since the prior version, or not and may provide indications to a user for further tuning of the ensemble model. A VoV comparison may be presented to a user via, for example, a model evaluation GUI that presents a predicted sequence of forecast values for a target time-series variable from both a previous execution of an ensemble model and a current execution of an ensemble model.

As another possibility, the model evaluation component 107 of the server-side software may cause the back-end computing platform 102 to carry out functionality that enables a user to view explanations of variances or differences in predicted forecast values between different executions of a given ensemble model (e.g., a prior vs. current execution). For instance, the back-end computing platform 102 installed with the model evaluation component 107 may function to (i) identify differences between a first set of forecast values predicted during a first execution of a given ensemble model and a second set of forecast values predicted during a second execution of a given ensemble model, (ii) perform an evaluation of which one or more inputs to the model execution process (e.g., which one or more the target time-series variable, the influencing variable(s), and/or the offset variable(s)) were the most likely driver(s) of each identified difference, which may utilize any technique now known or later developed for explaining changes in a time-series model's outputs in terms of the model's inputs (which may sometimes be referred to as model explanability or model interpretability techniques), and then (iii) cause a user to be presented with explanation information that indicates which one or more inputs to the model execution process were the most likely driver(s) of each identified difference between the first and second sets of forecast values.

To illustrate with an example, consider a scenario where a forecast value for a given time in the future (e.g., June 2024) increases by five percent increase between a first execution of a given ensemble model and a second execution of the given ensemble model. In this example, the foregoing functionality of the model evaluation component 107 may be used to determine and present that (i) one percent of the five percent increase in the forecast value for the given time in the future is most likely driven by a first influencing variable, (ii) two percent of the five percent increase in the forecast value for the given time in the future is most likely driven by a second influencing variable, and (iii) one percent of the five percent increase in the forecast value for the given time in the future is most likely driven by an offset variable or by the past values for the target time-series variable itself. Functionality for determining and presenting a user with observations of variances between different ensemble model executions may take various other forms as well.

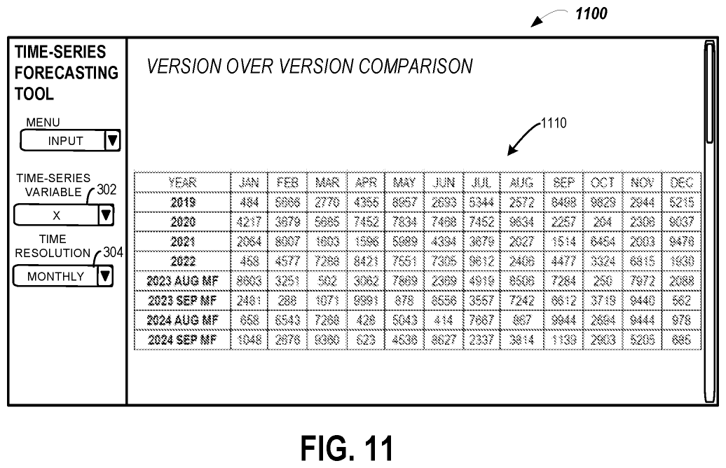

Turning now to FIG. 11, an example first GUI view 1100 for the model evaluation GUI that shows a view of a VoV comparison is, in accordance with the present disclosure is illustrated. As illustrated, an indication of a data table 1110 is presented via the first GUI view 1100. For example, the data table 1110 may include past real data and then multiple sets of predicted sequences of forecast values for a target time-series variable, based on different executions of the ensemble model. For example and as shown, the data table 1110 may show model forecast data values for a given time-series variable for the years 2023 and 2024 and show two predicted sequences of forecast values for a target time-series variable for each. The two differing predicted sequences of forecast values for a target time-series variable are from different executions of the ensemble mode (e.g., an August execution and a September execution). Thus, by presenting this data side-by-side, a user can draw a comparison of the output of the ensemble model, at different times.

As another possibility, the model evaluation component 107 of the server-side software 103 may cause the back-end computing platform 102 to carry out functionality that enables a user to view a variance in the output a predicted sequence of forecast values for a target time-series variable of the ensemble model, in comparison to a prior execution of the ensemble model and predicted sequence of forecast values for a target time-series variable.

As yet another possibility, the model evaluation component 107 of the server-side software 103 may cause the back-end computing platform 102 to carry out functionality that enables a user to input comments that will remain stored as a data object associated with the ensemble model. This may include comments that a user of the time-series forecasting tool may want to remember for future reference or may be instructions or comments provided to another user of the time-series forecasting tool. Such comments may take other forms as well.

The functionality that is carried out by the model evaluation component 107 in order to enable users to engage in tasks for evaluating and/or adjusting an ensemble model may take various other forms as well.

In the present disclosure, various example GUIs of the disclosed time-series forecasting tool have been described and shown, including the model setup GUI, the model configuration GUI, the model execution GUI, and the model evaluation GUI. And while these examples GUIs have been described and shown separately, it should be understood that any two or more of these GUIs may be combined together into a single, unified GUI of the disclosed time-series forecasting tool (in which case the GUIs described herein may comprise different “views” or “screens” of the unified GUI). The GUI(s) provided by the disclosed time-series forecasting tool may take various other forms as well.

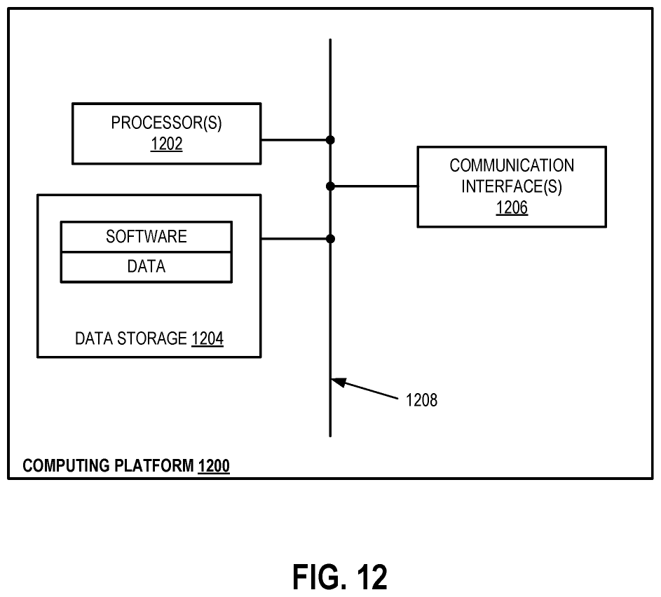

Turning now to FIG. 12, a simplified block diagram is provided to illustrate some structural components that may be included in an example computing platform 1200 that may be configured to perform some or all of the server-side functions disclosed herein. At a high level, computing platform 1200 may generally comprise any one or more computer systems (e.g., one or more servers) that collectively include one or more processors 1202, data storage 1204, and one or more communication interfaces 1206, all of which may be communicatively linked by a communication link 1208 that may take the form of a system bus, a communication network such as a public, private, or hybrid cloud, or some other connection mechanism. Each of these components may take various forms.

For instance, the one or more processors 1202 may comprise one or more processor components, such as one or more central processing units (CPUs), graphics processing unit (GPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 1202 could comprise processing components that are distributed across a plurality of physical computing devices connected via a network, such as a computing cluster of a public, private, or hybrid cloud.

In turn, data storage 1204 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 1204 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 12, data storage 1204 may be capable of storing both (i) program instructions that are executable by the one or more processors 1202 such that the computing platform 1200 is configured to perform any of the various functions disclosed herein (including but not limited to any of the server-side functions discussed above), and (ii) data that may be received, derived, or otherwise stored by computing platform 1200.

The one or more communication interfaces 1206 may comprise one or more interfaces that facilitate communication between computing platform 1200 and other systems or devices, where each such interface may be wired and/or wireless and may communicate according to any of various communication protocols. As examples, the one or more communication interfaces 1206 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

Although not shown, the computing platform 1200 may additionally have an I/O interface that includes or provides connectivity to I/O components that facilitate user interaction with the computing platform 1200, such as a keyboard, a mouse, a trackpad, a display screen, a touch-sensitive interface, a stylus, a virtual-reality headset, and/or one or more speaker components, among other possibilities.

It should be understood that computing platform 1200 is one example of a computing platform that may be used with the embodiments described herein. Numerous other arrangements are possible and contemplated herein. For instance, in other embodiments, the computing platform 1200 may include additional components not pictured and/or more or less of the pictured components.

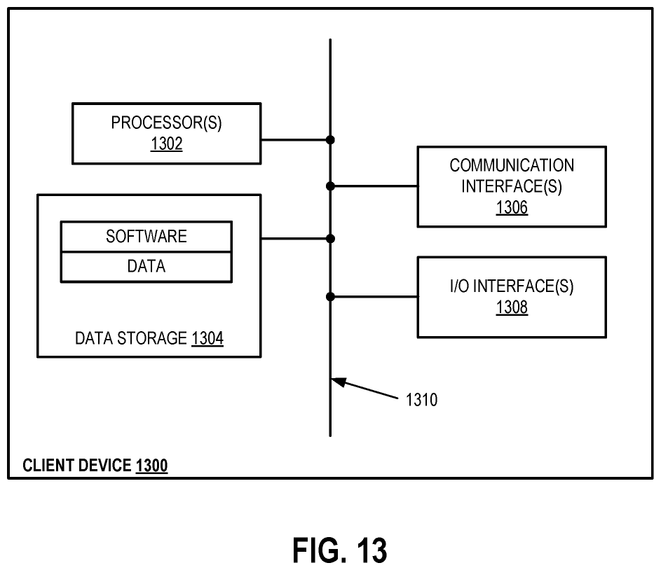

Turning next to FIG. 13, a simplified block diagram is provided to illustrate some structural components that may be included in an example client device 1300 that may be configured to perform some or all of the client-side functions disclosed herein. At a high level, the example client device 1300 may include one or more processors 1302, data storage 1304, one or more communication interfaces 1306, and an I/O interface 1308, all of which may be communicatively linked by a communication link 1310 that may take the form a system bus and/or some other connection mechanism. Each of these components may take various forms.

For instance, the one or more processors 1302 of the example client device 1300 may comprise one or more processor components, such as one or more CPUs, GPUs, ASICs, DSPs, and/or programmable logic devices such as FPGAs, among other possible types of processing components

In turn, the data storage 1304 of the example client device 1300 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 13, data storage 1304 may be capable of storing both (i) program instructions that are executable by the one or more processors 1302 of the example client device 1300 such that the client device 1300 is configured to perform any of the various functions disclosed herein (including but not limited to any of the client-side functions discussed above), and (ii) data that may be received, derived, or otherwise stored by the client device 1300.

The one or more communication interfaces 1306 may comprise one or more interfaces that facilitate communication between the client device 1300 and other systems or devices, where each such interface may be wired and/or wireless and may communicate according to any of various communication protocols. As examples, the one or more communication interfaces 1306 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 1308 may generally take the form of (i) one or more input interfaces that are configured to receive and/or capture information at the example client device 1300 and (ii) one or more output interfaces that are configured to output information from the example client device 1300 (e.g., for presentation to a user). In this respect, the one or more input interfaces of I/O interface may include or provide connectivity to input components such as a microphone, a camera, a keyboard, a mouse, a trackpad, a touchscreen, and/or a stylus, among other possibilities, and the one or more output interfaces of I/O interface may include or provide connectivity to output components such as a display screen and/or an audio speaker, among other possibilities.

It should be understood that the example client device 1300 is one example of a client device that may be used with the example embodiments described herein. Numerous other arrangements are possible and contemplated herein. For instance, in other embodiments, the example client device 1300 may include additional components not pictured and/or more or fewer of the pictured components.

### CONCLUSION

This disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners without departing from the true scope and spirit of the present invention, which will be defined by the claims.

Further, to the extent that examples described herein involve operations performed or initiated by actors, such as “humans,” “curators,” “users” or other entities, this is for purposes of example and explanation only. The claims should not be construed as requiring action by such actors unless explicitly recited in the claim language.

We claim:

1. A computing platform comprising:
at least one network interface;
at least one processor;
at least one non-transitory computer-readable medium; and
program instructions stored on the at least one non-transitory computer-readable medium that, when executed by the at least one processor, cause the computing platform to:
generate a first set of time-series models that are configured to predict forecast values of a target time-series variable for a first target timeframe, wherein the first set of time-series models comprises time-series models of at least two different model types;
generate a second set of time-series models that are configured to predict forecast values of a target time-series variable for a second target timeframe that differs from the first target timeframe, wherein the second set of time-series models comprises time-series models of at least two different model types;
cause a client device associated with a user to present a graphical user interface (GUI) that enables a user to configure an ensemble model for forecasting values of the target time-series variable;
receive, from the client device over a network-based communication path, configuration data for a given ensemble model that identifies a user-selected group of time-series models to be included in the given ensemble model, wherein the user-selected group of time-series models includes at least one time-series model from the first set of time-series models and at least one time-series model from the second set of time-series models;
based on the received configuration data, construct the given ensemble model from the user-selected group of time-series models, wherein the given ensemble model is configured to blend forecast values of the target time-series variable that are predicted by the user-selected group of time-series models; and
after constructing the given ensemble model, utilize the given ensemble model to predict a given sequence of forecast values for the target time-series variable.

2. The computing platform of claim 1, further comprising program instructions stored on the at least one non-transitory computer-readable medium that, when executed by the at least one processor, cause the computing platform to:
before generating the first and second sets of time-series models, obtain model setup parameters and source data for use in generating the first and second sets of time-series models.

3. The computing platform of claim 1, further comprising program instructions stored on the at least one non-transitory computer-readable medium that, when executed by the at least one processor, cause the computing platform to, before generating the first and second sets of time-series models:
obtain historical data for the target time-series variable;
obtain historical data for one or more offset variables; and
normalize the historical data for the target time-series variable based on the historical data for one or more offset variables, wherein the first and second sets of time-series models are thereafter generated based on the normalized historical data for the target time-series variable.

4. The computing platform of claim 1, wherein:
the program instructions that, when executed by the at least one processor, cause the computing platform to generate the first set of time-series models comprise program instructions stored on the at least one non-transitory computer-readable medium that, when executed by the at least one processor, cause the computing platform to, for each given model type of the at least two different model types:
train a given batch of candidate time-series models of the given model type that are configured to predict forecast values of the target time-series variable for the first target timeframe, wherein the candidate time-series models in the given batch have different hyperparameter combinations;
based on an evaluation of the given batch of candidate time-series models of the given model type, determine a respective measure of performance for each of the different hyperparameter combinations;
identify a hyperparameter combination that has a best measure of performance relative to other hyperparameter combinations; and
select a candidate time-series model having the identified hyperparameter combination as a time-series model of the given model type to include in the first set of time-series models; and
the program instructions that, when executed by the at least one processor, cause the computing platform to generate the second set of time-series models comprise program instructions stored on the at least one non-transitory computer-readable medium that, when executed by the at least one processor, cause the computing platform to, for each given model type of the at least two different model types:
train a given batch of candidate time-series models of the given model type that are configured to predict forecast values of the target time-series variable for the second target timeframe, wherein the candidate time-series models in the given batch have different hyperparameter combinations;
based on an evaluation of the given batch of candidate time-series models of the given model type, determine a respective measure of performance for each of the different hyperparameter combinations;
identify a hyperparameter combination that has a best measure of performance relative to other relative to other hyperparameter combinations; and
select a candidate time-series model having the identified hyperparameter combination as a time-series model of the given model type to include in the second set of time-series models.

5. The computing platform of claim 4, wherein:
in the given batch of candidate time-series models for each given model type of the at least two different model types of the first set of time-series models, the different hyperparameter combinations are selected using grid search; and
in the given batch of candidate time-series models for each given model type of the at least two different model types of the second set of time-series models, the different hyperparameter combinations are selected using grid search.

6. The computing platform of claim 4, wherein:
based on the evaluation of the given batch of candidate time-series models for each given model type of the at least two different model types of the first set of time-series models, the respective measure of performance that is determined for each of the different hyperparameter combinations comprises a respective mean absolute percentage error (MAPE) value; and
based on the evaluation of the given batch of candidate time-series models for each given model type of the at least two different model types of the second set of time-series models, the respective measure of performance that is determined for each of the different hyperparameter combinations comprises a respective MAPE value.

7. The computing platform of claim 1, wherein the at least two different model types of the first set of time-series models and the at least two different model types of the second set of time-series models each comprises at least two of (i) a Seasonal Autoregressive Integrated Moving-Average with exogenous regressors (SARIMAX) type of time-series model, (ii) an Unobserved Components type of time-series model, (iii) an Exponential Smoothing type of time-series model, or (iv) a Prophet type of time-series model.

8. The computing platform of claim 1, wherein the given ensemble model is configured to blend the forecast values of the target time-series variable that are output by the at least one time-series model from the first set of time-series models for the first target timeframe across time with the forecast values of the target time-series variable that are output by at least one time-series model from the second set of time-series models for the second target timeframe.

9. The computing platform of claim 1, wherein the user-selected group of time-series models includes two or more time-series models from the first set of time-series models, and wherein the configuration data comprises respective weight value for the two or more time-series models from the first set of time-series models.

10. The computing platform of claim 9, wherein the given ensemble model is configured to blend the forecast values of the target time-series variable that are output by the two or more time-series models from the first set of time-series models in accordance with the respective weight values for the two or more time-series models from the first set of time-series models.

11. The computing platform of claim 1, wherein the time-series models in the first and second sets each have:
a first input feature corresponding to the target time-series variable; and
one or more additional input features corresponding to one or more influencing variables.

12. The computing platform of claim 1, further comprising program instructions stored on the at least one non-transitory computer-readable medium that, when executed by the at least one processor, cause the computing platform to:
cause the client device associated with the user to present the given sequence of forecast values for the target time-series variable.

13. A non-transitory computer-readable medium, wherein the non-transitory computer-readable medium is provisioned with program instructions that, when executed by at least one processor, cause a computing platform to:
generate a first set of time-series models that are configured to predict forecast values of a target time-series variable for a first target timeframe, wherein the first set of time-series models comprises time-series models of at least two different model types;
generate a second set of time-series models that are configured to predict forecast values of a target time-series variable for a second target timeframe that differs from the first target timeframe, wherein the second set of time-series models comprises time-series models of at least two different model types;
cause a client device associated with a user to present a graphical user interface (GUI) that enables a user to configure an ensemble model for forecasting values of the target time-series variable;
receive, from the client device over a network-based communication path, configuration data for a given ensemble model that identifies a user-selected group of time-series models to be included in the given ensemble model, wherein the user-selected group of time-series models includes at least one time-series model from the first set of time-series models and at least one time-series model from the second set of time-series models;
based on the received configuration data, construct the given ensemble model from the user-selected group of time-series models, wherein the given ensemble model is configured to blend forecast values of the target time-series variable that are predicted by the user-selected group of time-series models; and
after constructing the given ensemble model, utilize the given ensemble model to predict a given sequence of forecast values for the target time-series variable.

14. The non-transitory computer-readable medium of claim 13, wherein the non-transitory computer-readable medium is also provisioned with program instructions that, when executed by at least one processor, cause the computing platform to:
before generating the first and second sets of time-series models, obtain model setup parameters and source data for use in generating the first and second sets of time-series models.

15. The non-transitory computer-readable medium of claim 13, wherein the non-transitory computer-readable medium is also provisioned with program instructions that, when executed by at least one processor, cause the computing platform to:
obtain historical data for the target time-series variable;
obtain historical data for one or more offset variables; and
normalize the historical data for the target time-series variable based on the historical data for one or more offset variables, wherein the first and second sets of time-series models are thereafter generated based on the normalized historical data for the target time-series variable.

16. The non-transitory computer-readable medium of claim 13, wherein the given ensemble model is configured to blend the forecast values of the target time-series variable that are output by the at least one time-series model from the first set of time-series models for the first target timeframe across time with the forecast values of the target time-series variable that are output by at least one time-series model from the second set of time-series models for the second target timeframe.

17. A method implemented by a computing platform, the method comprising:
generating a first set of time-series models that are configured to predict forecast values of a target time-series variable for a first target timeframe, wherein the first set of time-series models comprises time-series models of at least two different model types;
generating a second set of time-series models that are configured to predict forecast values of a target time-series variable for a second target timeframe that differs from the first target timeframe, wherein the second set of time-series models comprises time-series models of at least two different model types;
causing a client device associated with a user to present a graphical user interface (GUI) that enables a user to configure an ensemble model for forecasting values of the target time-series variable;
receiving, from the client device over a network-based communication path, configuration data for a given ensemble model that identifies a user-selected group of time-series models to be included in the given ensemble model, wherein the user-selected group of time-series models includes at least one time-series model from the first set of time-series models and at least one time-series model from the second set of time-series models;
based on the received configuration data, constructing the given ensemble model from the user-selected group of time-series models, wherein the given ensemble model is configured to blend forecast values of the target time-series variable that are predicted by the user-selected group of time-series models; and
after constructing the given ensemble model, utilizing the given ensemble model to predict a given sequence of forecast values for the target time-series variable.

18. The method of claim 17, further comprising:
before generating the first and second sets of time-series models, obtaining model setup parameters and source data for use in generating the first and second sets of time-series models.

19. The method of claim 17, further comprising:
obtaining historical data for the target time-series variable;
obtaining historical data for one or more offset variables; and
normalizing the historical data for the target time-series variable based on the historical data for one or more offset variables, wherein the first and second sets of time-series models are thereafter generated based on the normalized historical data for the target time-series variable.

20. The method of claim 17, wherein the given ensemble model is configured to blend the forecast values of the target time-series variable that are output by the at least one time-series model from the first set of time-series models for the first target timeframe across time with the forecast values of the target time-series variable that are output by at least one time-series model from the second set of time-series models for the second target timeframe.
